(19) United States
(12) Patent Application Publication
(10) Pub. No.: US 2008/0152025 A1
(43) Pub. Date: Jun. 26, 2008

(54) Signal Bypass Device

(75) Inventor: Toru Kimura, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUISHI ELECTRIC CORPORATION, Chiyoda-ku (JP)

(21) Appl. No.: 11/817,341

(22) PCT Filed: Mar. 7, 2005
(86) PCT No.: PCT/JP2005/003895

§ 371 Date: Aug. 29, 2007

(51) Int. Cl. H04B 3/00

(52) U.S. Cl. 375/258

(57) ABSTRACT

To obtain a signal bypass device capable of bypassing a device irrespective of a type of device to be bypassed and capable of facilitating the installation of the signal bypass device, in carrying out power line communication of transmitting a high-frequency signal using a power line and in transmitting a high-frequency signal using an arbitrary electric wire.

When a communication interference device is present in the middle of two electric wires, the signal bypass device includes: split cores each of which is disposed in two electric wires at both ends of the communication interference device; a cable wired through the split cores at both ends of the communication interference device so that the split cores at both ends of the communication interference device function as transformers; and at least one of series capacitors present in the cable and parallel capacitors disposed between lines of the cable, the capacitors being provided near parts where the cable passes through the split cores at both ends of the communication interference device.

### TECHNICAL FIELD

The present invention relates to a signal bypass device that transmits a communication signal on an electric wire by bypassing a communication interference device present in the middle of the electric wire.

### BACKGROUND ART

As a signal bypass transmission method of transmitting a communication signal on an electric wire by bypassing a communication interference device present in the middle of the electric line, there has been known a method of transmitting a communication signal on high-voltage distribution lines to a low-voltage distribution lines by bypassing a power distribution transformer, because the power distribution transformer gives a communication interference, in the power line communication for transmitting a high-frequency signal using electric power lines (for example, Patent Documents 1 to 3).

The Patent Document 1 discloses a signal transmission method (i.e., a signal bypass transmission method) as follows. A high-frequency communication signal is superimposed on high-voltage distribution lines. First capacitors and a resistor connected in series with the capacitors are formed between phases of the high-voltage distribution lines. Both ends of the resistor are connected to low-voltage distribution lines, thereby transmitting the high-frequency communication signal from the high-voltage distribution lines to the low-voltage distribution lines by bypassing a power distribution transformer.

The Patent Document 2 discloses a method of bypassing a breaker and a voltmeter using a signal line, by magnetically connecting a signal line to two power lines before a secondary-side breaker of a transformer and to two power lines that have passed a voltmeter of a consumer, respectively.

The Patent Document 3 discloses a method of inserting a bandpass filter into between two transistors T1 and T2, by forming a capacitor C1 and an LC low-pass filter, using inductance component of windings of the two transformers T1 and T2.

Patent Document 1: Japanese Patent Application Laid-open No. 2002-217796

Patent Document 2: Japanese Patent Application Laid-open No. 2004-282397

Patent Document 3: Japanese Patent Application Laid-open No. 2003-174349

### DISCLOSURE OF INVENTION

### Problem to be Solved by the Invention

However, the signal bypass transmission methods according to the conventional techniques have a problem of an influence of a distributor to be bypassed. For example, when the distributor to be bypassed has a branch like a distribution board, there is an influence of signal reflection from a branch end. Therefore, a transmission characteristic of the signal to be bypassed becomes poor.

The conventional signal bypass transmission method employs a method of winging a conductive tape or sheet around an insulation cover of high-voltage (low-voltage) distribution lines, or a method of sandwiching an insulation cover of a high-voltage (low-voltage) distribution lines between divided pieces of a conductive cylindrical member, as a method of forming a capacitor. The capacitor is formed over a length of 1 meter of an electric wire to secure a transmission characteristic. The work of forming the capacitor is not easy, as explained above.

On the other hand, not only power line communication of transmitting a high-frequency signal can be carried out using an electric power line, but also a high-frequency signal can be transmitted. Because an electric wire is connected via a switch, when the switch is in an opened state, the switch becomes a communication interference device. When the electric wires at both ends of the switch can be connected by bypassing the switch, a high-frequency signal can be transmitted using an arbitrary electric wire.

The present invention has been achieved in view of the problems described above, and an object of the present invention is to provide a signal bypass device capable of bypassing a device irrespective of a type of device to be bypassed and capable of facilitating the installation of the signal bypass device, in carrying out power line communication of transmitting a high-frequency signal using a power line and in transmitting a high-frequency signal using an arbitrary electric wire.

### Means for Solving Problem

To achieve the above object, a signal bypass device according to the present invention includes, when a communication interference device is present in the middle of two electric wires, split cores arranged on each of the two electric wires at both ends of the communication interference device; a cable wired through the split cores on each side of the ends of the communication interference device in such a manner that the split cores at both ends of the communication interference device function as transformers; and at least one of a series capacitor through which the cable is connected and a parallel capacitor arranged across lines of the cable, the capacitors being provided near a portion where the cable passes through the split cores on each side of the ends of the communication interference device. Furthermore, the signal bypass device includes a capacitor connecting electric wire connection ends on each side of the ends of the communication interference device.

According to the present invention, there is no influence of characteristic of a communication interference device due to capacitance components of capacitors connecting between electric wire connection ends at ends of the communication interference device or inductance components of split cores disposed in electric wires. Therefore, any device can be bypassed irrespective of a type of device to be bypassed. Power line communication of transmitting a high-frequency signal can be carried out using a power line, and a high-frequency signal can be transmitted using an arbitrary electric wire. In this case, a series capacitor and a parallel capacitor form a high-pass filter or a low-pass filter, by combining inductance components of transformers functioned by split cores. Therefore, loss characteristics in a desired frequency band can be decreased. Because the split cores can be disposed to sandwich an electric wire, an electric wire can be fitted in an active state when the electric wire is a power supply line such as an electric power line.

### EFFECT OF THE INVENTION

According to the present invention, a signal bypass device capable of bypassing a device irrespective of a type of device and capable of facilitating the installation of the signal bypass device can be obtained, in carrying out power line communication of transmitting a high-frequency signal using a power line, and in transmitting a high-frequency signal using an arbitrary electric wire.

### BRIEF DESCRIPTION OF DRAWINGS

FIG. 1 depicts a layout of a signal bypass device according to a first embodiment of the present invention.

FIG. 2 is an equivalent circuit diagram of a circuit configuration of the signal bypass device shown in FIG. 1.

FIG. 3A is an equivalent circuit diagram (part 1) that can be derived from the equivalent circuit shown in FIG. 2.

FIG. 3B is an equivalent circuit diagram (part 2) that can be derived from the equivalent circuit shown in FIG. 2.

FIG. 4 is a characteristic diagram (part 1) of an example of a loss characteristic of the signal bypass device shown in FIG. 1.

FIG. 5 is a characteristic diagram (part 2) of an example of a loss characteristic of the signal bypass device shown in FIG. 1.

FIG. 6 is a characteristic diagram (part 3) of an example of a loss characteristic of the signal bypass device shown in FIG. 1.

FIG. 7 depicts a layout of a signal bypass device according to a second embodiment of the present invention.

FIG. 8 is an equivalent circuit diagram of a circuit configuration of the signal bypass device shown in FIG. 7.

FIG. 9 depicts a layout of a signal bypass device according to a third embodiment of the present invention.

FIG. 10 is an equivalent circuit diagram of a circuit configuration of the signal bypass device shown in FIG. 9.

FIG. 11 depicts a layout of a signal bypass device according to a fourth embodiment of the present invention.

FIG. 12 is an equivalent circuit diagram of a circuit configuration of the signal bypass device shown in FIG. 11.

FIG. 13 depicts a layout of a signal bypass device according to a fifth embodiment of the present invention.

FIG. 14 is an equivalent circuit diagram of a circuit configuration of the signal bypass device shown in FIG. 13.

FIG. 15 depicts a layout of a signal bypass device according to a sixth embodiment of the present invention.

FIG. 16 is an equivalent circuit diagram of a circuit configuration of the signal bypass device shown in FIG. 15.

FIG. 17 depicts a layout of a signal bypass device according to a seventh embodiment of the present invention.

FIG. 18 is an equivalent circuit diagram of a circuit configuration of the signal bypass device shown in FIG. 17.

FIG. 19 depicts a layout of a signal bypass device according to an eighth embodiment of the present invention.

FIG. 20 is an equivalent circuit diagram of a circuit configuration of the signal bypass device shown in FIG. 19.

FIG. 21 depicts a layout of a signal bypass device according to a ninth embodiment of the present invention.

FIG. 22 is an equivalent circuit diagram of a circuit configuration of the signal bypass device shown in FIG. 21.

FIG. 23 depicts a layout of a signal bypass device according to a tenth embodiment of the present invention.

FIG. 24 is an equivalent circuit diagram of a circuit configuration of the signal bypass device shown in FIG. 23.

### EXPLANATIONS OF LETTERS OR NUMERALS

1 to 4, 21 to 24, 25 to 28 Distribution line
5 Distributor
6a, 6b, 7a, 7b Split core 9a, 9b, 15, 16, 17, 17a, 17b, 18, 18a, 18b, 27a, 27b, 27c, 27d, 28a, 28b, 28c, 28d Capacitor
10, 20, 31, 32, 41, 42, 51, 52, 61, 62, 70, 80, 91, 92, 101, 102, 111, 112 Cable
10a, 10b, 20a, 20b, 31a, 31b, 32a, 32, 41a, 41b, 42a, 42b, 51a, 51b, 52a, 52b, 61a, 61b, 62a, 62b, 70a, 70b, 80a, 80b, 91a, 91b, 92a, 92b, 101a, 101b, 102a, 102b, 111a, 111b, 112a, 112b Communication line
29a, 29b Transformer
A1, A2, B1, B2 Connection point
TL10, TL20, TL31, TL32, TL41, TL42, TL51, TL52, TL61, TL62, TL70, TL80, TL91, TL92, TL101, TL102, TL111, TL112 Transmission line
Cs15, Cs16, Cs17, Cs18, C1, C2, Cs17a, Cs17b, Cs18a, Cs18b, Cs27a, Cs27b, Cs27c, Cs27d, Cs28a, Cs28b, Cs28c, Cs28d Capacitor
T1 to T4 Transformer

### BEST MODE(S) FOR CARRYING OUT THE INVENTION

Exemplary embodiments of a signal bypass device according to the present invention are explained in detail below with reference to the accompanying drawings.

### First Embodiment

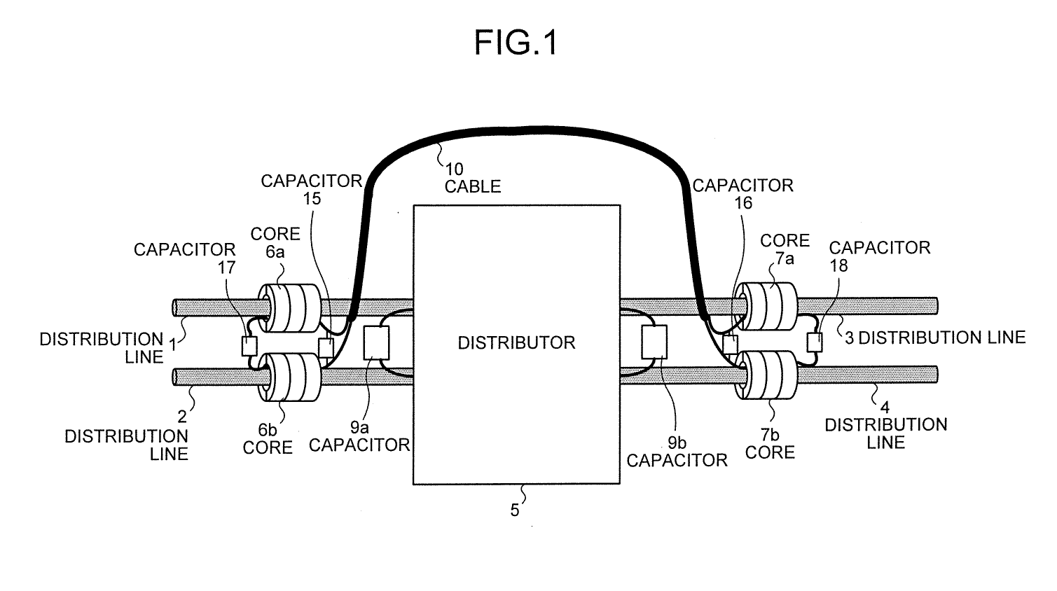

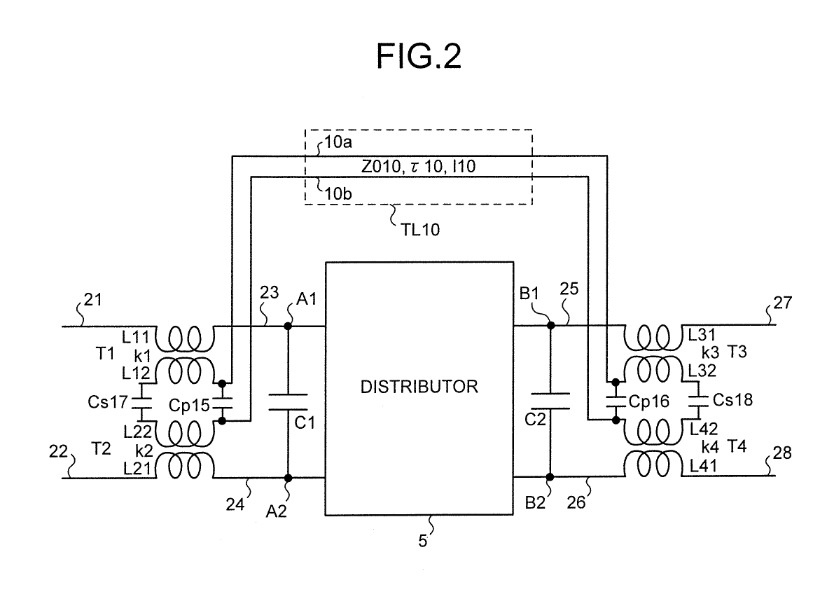

FIG. 1 depicts a layout of a signal bypass device according to a first embodiment of the present invention. FIG. 2 is an equivalent circuit diagram of a circuit configuration of the signal bypass device shown in FIG. 1. In the first embodiment and subsequent embodiments, power line communication for transmitting a high-frequency signal using an electric power line is explained as an example to facilitate the understanding of the present invention.

As shown in FIG. 1, a distributor 5 that becomes communication interference is disposed between distribution lines 1 and 2 and distribution lines 3 and 4. The distributor 5 is a distribution board, a pole-mounted transformer, a capacitor bank, or the like. A bypass device shown in FIG. 1 is configured to form a communication path of a high-frequency signal by connecting in high frequency between the distribution lines 1 and 2 at one end side and the distribution lines 3 and 4 at a side of the second end of the distributor 5, by bypassing the distributor 5.

Specifically, split cores 6a and 6b are disposed to sandwich the distribution lines 1 and 2, respectively at a first end of the distributor 5, and split cores 7a and 7b are disposed to sandwich the distribution lines 3 and 4, respectively, at a second end of the distributor 5. The cores 6a and 6b and the cores 7a and 7b are connected to each other, respectively, by a cable 10 that passes through the cores. With this arrangement, each of the cores 6a, 6b, 7a, and 7b functions as a transformer. A capacitor 9a is installed between connection ends of the distributor 5 and connection ends of the distribution lines 1 and 2, and a capacitor 9b is installed between connection ends of the distributor 5 and connection ends of the distribution lines 3 and 4.

One communication line out of the two communication lines at one end of the cable 10 is sandwiched by the core 6a in a state that the front end of the one communication line is stretched, and the other communication line is sandwiched by the core 6b in a state that the front end of the other communication line is stretched. A capacitor 15 is connected between the two communication lines at the input side of the cores 6a and 6b. The front ends of the two communication lines stretched from the cores 6a and 6b are connected to each other via a capacitor 17.

Similarly, one communication line out of the two communication lines at the other end of the cable 10 is sandwiched by the core 7a in a state that the front end of the one communication line is stretched, and the other communication line is sandwiched by the core 7b in a state that the front end of the other communication line is stretched. A capacitor 16 is connected between the two communication lines at the input side of the cores 7a and 7b. The front ends of the two communication lines stretched from the cores 7a and 7b are connected to each other via a capacitor 18.

As a result, a circuit configuration of the signal bypass device shown in FIG. 1 becomes the configuration shown in FIG. 2. In FIG. 2, at the first end of the distributor 5, the other end of a distribution line 21 of which one end is connected to the outside is connected to one end of a distribution line 23 via one input-and-output side winding of a transformer T1 formed by the core 6a, and the other end of the distribution line 23 is connected to a connection point A1 at a side of the first end of the distributor 5. The above explains the relationship between the distribution line 1 and the core 6a shown in FIG. 1.

The other end of a distribution line 22 of which one end is connected to the outside is connected to one end of a distribution line 24 via one input-and-output side winding of a transformer T2 formed by the core 6b, and the other end of the distribution line 24 is connected to a connection point A2 at the first end of the distributor 5. The above explains the relationship between the distribution line 2 and the core 6b shown in FIG. 1.

Similarly, at the second end of the distributor 5, the other end of a distribution line 27 of which one end is connected to the outside is connected to one end of a distribution line 25 via one input-and-output side winding of a transformer T3 formed by the core 7a, and the other end of the distribution line 25 is connected to a connection point B1 at the second end of the distributor 5. The above explains the relationship between the distribution line 3 and the core 7a shown in FIG. 1.

The other end of a distribution line 28 of which one end is connected to the outside is connected to one end of a distribution line 26 via one input-and-output side winding of a transformer T4 formed by the core 7b, and the other end of the distribution line 26 is connected to a connection point B2 at the second end of the distributor 5. The above explains the relationship between the distribution line 4 and the core 7b shown in FIG. 1.

One end of other input-and-output winding of the transformer T1 and one end of the other input-and-output winding of the transformer T2 are connected to each other via a capacitor Cs17 as the capacitor 17. The other end of other input-and-output winding of the transformer T1 and the other end of the other input-and-output winding of the transformer T2 are connected to each other via a capacitor Cs15 as the capacitor 15. One end of other input-and-output winding of the transformer T3 and one end of the other input-and-output winding of the transformer T4 are connected to each other via a capacitor Cs18 as the capacitor 18. The other end of other input-and-output winding of the transformer T3 and the other end of the other input-and-output winding of the transformer T4 are connected to each other via a capacitor Cs16 as the capacitor 16.

The cable 10 shown in FIG. 1 includes a communication line 10a that connects between the other ends of the other input-and-output side windings respectively of the transformer T1 and the transformer T3, and a communication line 10b that connects between the other ends of the other input-and-output side windings respectively of the transformer T2 and the transformer T4. Characteristic of a transmission line TL10 formed by the communication lines 10a and 10b is determined by characteristic impedance Z010, a transmission delay τ10 per unit length, and a line length l10.

In the transformer T1, one input-and-output winding has a self-inductance L11 at the distribution line side, and the other input-and-output winding has a self-inductance L12 at the cable side, and the transformer T1 has a coupling coefficient k1. Similarly, in the transformer T2, one input-and-output winding has a self-inductance L21 at the distribution line side, and the other input-and-output winding has a self-inductance L22 at the cable side, and the transformer T2 has a coupling coefficient k2.

In the transformer T3, one input-and-output winding has a self-inductance L31 at the distribution line side, and the other input-and-output winding has a self-inductance L32 at the cable side, and the transformer T3 has a coupling coefficient k3. Similarly, in the transformer T4, one input-and-output winding has a self-inductance L41 at the distribution line side, the other input-and-output winding has a self-inductance L42 at the cable side, and the transformer T4 has a coupling coefficient k4.

The above explains the relationship between the cores 6a and 6b, the cable 10, the cores 7a and 7b, the capacitor 17, the capacitor 15, the capacitor 18, and the capacitor 16 shown in FIG. 1. The capacitor C1 as the capacitor 9a shown in FIG. 1 is connected across the connection point A1 and the connection point A2 at the first end of the distributor 5. The capacitor C2 as the capacitor 9b shown in FIG. 1 is connected across the connection point B1 and the connection point B2 of the distributor 5.

Next, the operation of the signal bypass device according to the first embodiment having the configuration described above is explained below with reference to FIG. 2. First, a signal bypass method of extracting high-frequency signals of power line communication from the transformers T1 and T2 injected into one side of the distribution lines 21 and 22, and injecting the extracted high-frequency signals into the transformers T3 and T4 via the communication lines 10a and 10b is explained.

At one end of the distribution lines 21 and 22, power line communication signals that are high-frequency signals are superimposed on the electric power of a commercial frequency. Out of these signals, only the high-frequency signals are taken out to the communication lines 10a and 10b by the transformers T1 and T2, respectively. The extracted high-frequency signals are transmitted to the input and output windings at one side of the transformers T3 and T4, and are injected into the distribution lines 27 and 28 from the input and output windings at the other side of the transformers T3 and T4. In this case, the capacitor C1 disposed between the connection point A1 and the connection point A2 of the distributor 5 has the following two functions.

A first function is to avoid the appearance of a loss characteristic of the distributor 5 at the point of extracting the high-frequency signals, in the high-frequency band used by the high-frequency signals, by decreasing the high-frequency impedance between the connection point A1 and the connection point A2. The distributor 5 is a distribution board, a pole-mounted transformer, and a capacitor bank. Each distributor has its own loss characteristic. In this case, the capacitor C1 is disposed between the connection point A1 and the connection point A2 of the distributor 5. With this arrangement, high-frequency signals are short-circuited between the connection point A1 and the connection point A2. Therefore, the loss characteristic of the distributor 5 does not appear at the point of extracting high-frequency signals. Namely, the transformers T1 and T2 can extract the high-frequency signals from the distribution lines 21 and 22, and transmit the signals to the communication lines 10a and 10b, without being affected by the characteristics of the distributor 5.

A second function is to increase the efficiency of extracting the high-frequency signals by the transformers T1 and T2. The transformer T1 generates a potential difference between the distribution line 21 and the distribution line 23 by an amount of impedance component due to the inductance of the transformer. Similarly, the transformer T2 generates a potential difference between the distribution line 22 and the distribution line 24 by an amount of impedance component due to the inductance of the transformer. In this case, a voltage of the high-frequency signal from the distribution line 21 and the distribution line 22 is distributed according to proportions of a potential difference generated in the transformer T1, a potential difference generated in the transformer T2, and a potential difference between the connection point A1 and the connection point A2 of the distributor 5. It is when the potential difference generated in each of the transformers T1 and T2 is minimized, i.e., the impedance between the connection point A1 and the connection point A2 becomes zero.

Therefore, the potential differences generated in the transformers T1 and T2 can be maximized, by connecting the capacitor C1 across the connection point A1 and the connection point A2 to short-circuit the high-frequency signals. As a result, the efficiency of extracting the high-frequency signals from the distribution lines 21 and 22 by the transformers T1 and T2 can be increased.

Similarly, the capacitor C2 disposed between the connection point B1 and the connection point B2 of the distributor 5 has the following two functions. A first function is to avoid the appearance of a loss characteristic of the distributor 5 at the point of extracting the high-frequency signals, in the high-frequency band used by the high-frequency signals, by decreasing the high-frequency impedance between the connection point B1 and the connection point B2. The distributor 5 is a distribution board, a pole-mounted transformer, and a capacitor bank. Each distributor has its own loss characteristic. In this case, the capacitor C2 is disposed between the connection point B1 and the connection point B2 of the distributor 5. With this arrangement, high-frequency signals are short-circuited between the connection point B1 and the connection point B2. Therefore, the loss characteristic of the distributor 5 does not appear at the point of extracting high-frequency signals. Namely, the transformers T3 and T4 can extract the high-frequency signals from the communication lines 10a and 10b, and transmit the signals to the distribution lines 25 and 27, without being affected by the characteristics of the distributor 5.

A second function is to increase the efficiency of injecting the high-frequency signals from the transformers T3 and T4 into the distribution lines 25 and 27. The transformer T3 generates a potential difference between the distribution line 25 and the distribution line 27 by an amount of impedance component due to the inductance of the transformer. Similarly, the transformer T4 generates a potential difference between the distribution line 26 and the distribution line 27 by an amount of impedance component due to the inductance of the transformer. In this case, a potential difference generated in the transformer T3 and a potential difference generated in the transformer T4 are distributed according to proportions of a potential difference between the connection point B1 and the connection point B2 of the distributor 5 and a potential difference due to a terminal resister of a receiving-side device connected to the distribution lines 27 and 28. A potential difference due to the terminal resistor of the receiving-side device is maximized when a potential difference between the connection point B1 and the connection point B2 of the distributor is minimized, i.e., when the impedance between the connection point B1 and the connection point B2 becomes zero. Therefore, the efficiency of injecting the high-frequency signals by the transformers T3 and T4 into the distribution lines 25 and 27 can be increased, by connecting the capacitor C2 across the connection point B1 and the connection point B2 to short-circuit the high-frequency signals.

The capacitor C1 disposed between the connection point A1 and the connection point A2 of the distributor 5 constitutes an LC low-pass filter, together with the transformers T1 and T2. To avoid giving influence to the power of a commercial frequency, inductance values of the transformers T1 and T2 and a capacitance value of the capacitor C1 need to be properly set so that a cutoff frequency of the LC low-pass filter is higher than the commercial frequency and is lower than the frequency of a high-frequency signal.

Similarly, the capacitor C2 disposed between the connection point B1 and the connection point B2 of the distributor 5 constitutes an LC low-pass filter, together with the transformers T3 and T4. To avoid giving influence to the power of a commercial frequency, inductance values of the transformers T3 and T4 and a capacitance value of the capacitor C2 need to be properly set so that a cutoff frequency of the LC low-pass filter is higher than the commercial frequency and is lower than the frequency of a high-frequency signal.

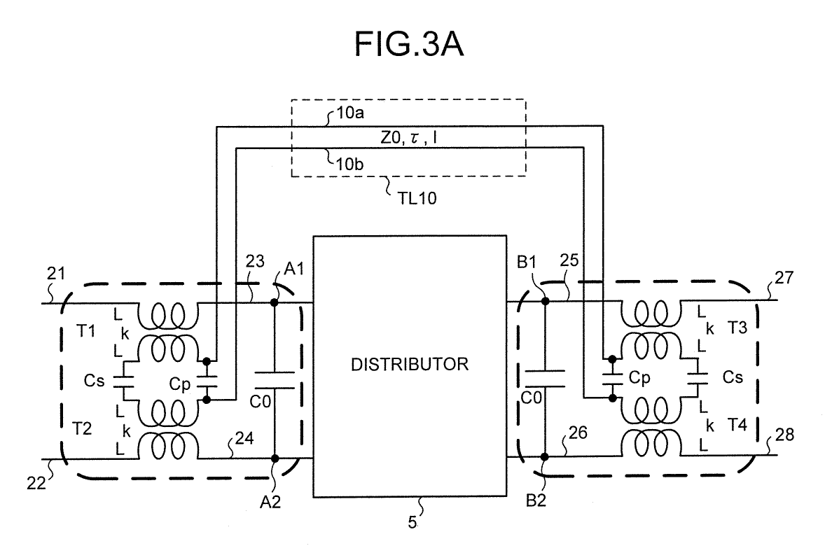

Effects of capacitors Cp15, Cp16, Cs17, and Cs18 are explained with reference to FIG. 3A and FIG. 3B. FIG. 3A depicts an equivalent circuit (part 1) that can be derived from the equivalent circuit shown in FIG. 2. FIG. 3B depicts an equivalent circuit (part 2) that can be derived from the equivalent circuit shown in FIG. 2.

The equivalent circuit shown in FIG. 3A is obtained by applying the following condition to the equivalent circuit shown in FIG. 2. In the transformers T1, T2, T3, and T4, L11=L12=L21=L22=L31=L32=L41=L42=L, and k1=k2=k3=k4=k, Cs17=Cs18=Cs, and Cp15=Cp16=Cp. In the transmission line TL10, Z010=Z0, τ10=τ and l10=l.

In the equivalent circuit shown in FIG. 3A, the transformers T1 and T2 are collectively shown as a transformer 29a, which becomes a T-shape circuit including a mutual inductance k*2L as one element, and a leakage inductance (1−k)*2L as two elements. Similarly, the transformers T3 and T4 are collectively shown as a transformer 29b, which becomes a T-shape circuit including the mutual inductance k*2L as one element, and the leakage inductance (1−k)*2L as two elements. FIG. 3B depicts these circuits.

With the arrangement described above, a high-pass filter (HPF) including the mutual inductance k*2L and the capacitor Cs is configured at the left part of the distributor 5. Further, a low-pass filter (LPF) including the two elements of the leakage inductance (1−k)*2L and the capacitor Cp is configured. At the right side of the distributor 5, a high-pass filter (HPF) including the mutual inductance k*2L and the capacitor Cs is configured. Further, a low-pass filter (LPF) including the two elements of the leakage inductance (1−k)*2L and the capacitor Cp is also configured.

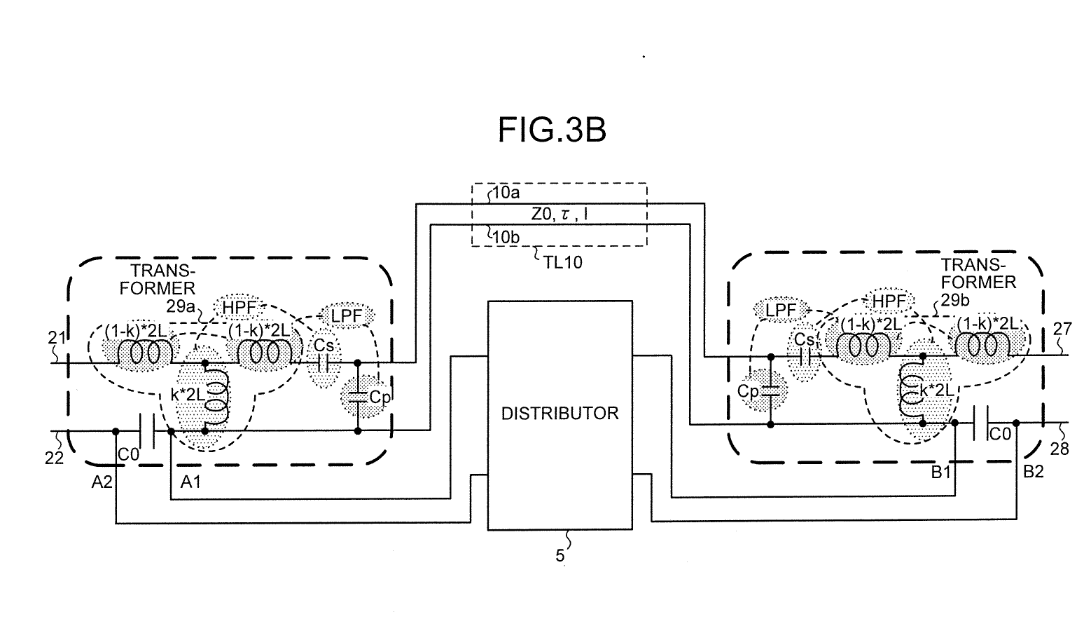

FIG. 4 is a characteristic diagram (part 1) of an example of a loss characteristic of the signal bypass device shown in FIG. 1. FIG. 4 depicts the effect of the capacitor Cs when the capacitor Cp is zero. A lateral axis of a graph shown in FIG. 4 represents frequency, and a vertical axis represents loss depending on the capacitor Cs when the capacitor Cp is zero.

In FIG. 4, a curve (a) indicated by a broken line represents a loss characteristic when the capacitor Cs is zero, i.e., when the capacitors Cs17 and Cs18 are not present, and when a corresponding of the input and output winding is directly connected. In this case, the capacitor Cp is zero, too. At the low-frequency side of the loss characteristic (a), loss becomes large mainly due to reactance shortage of the mutual inductance k*2L.

On the other hand, curves (b), (c), and (d) indicated by solid lines represent loss characteristics when the capacitor Cs is changed. The curve (b) shows loss characteristic when the capacitor Cs is large. The curve (c) shows loss characteristic when the capacitor Cs is optimum. The curve (d) shows loss characteristic when the capacitor Cs is small.

As shown in FIG. 4, when the capacitor Cs is present, particularly, the loss characteristic at the low-frequency side changes according to the capacitor Cs, unlike when the capacitor Cs is zero. Because the high-pass filter (HPF) is formed by the capacitor Cs and one element of the mutual inductance k*2L, sharpness of rise at the end of the cutoff frequency of the high-pass filter and the pass area and sharpness of the loss band change according to the capacitor Cs. Therefore, a suitable value of the capacitor Cs in the lowest loss area of a desired frequency band is selected.

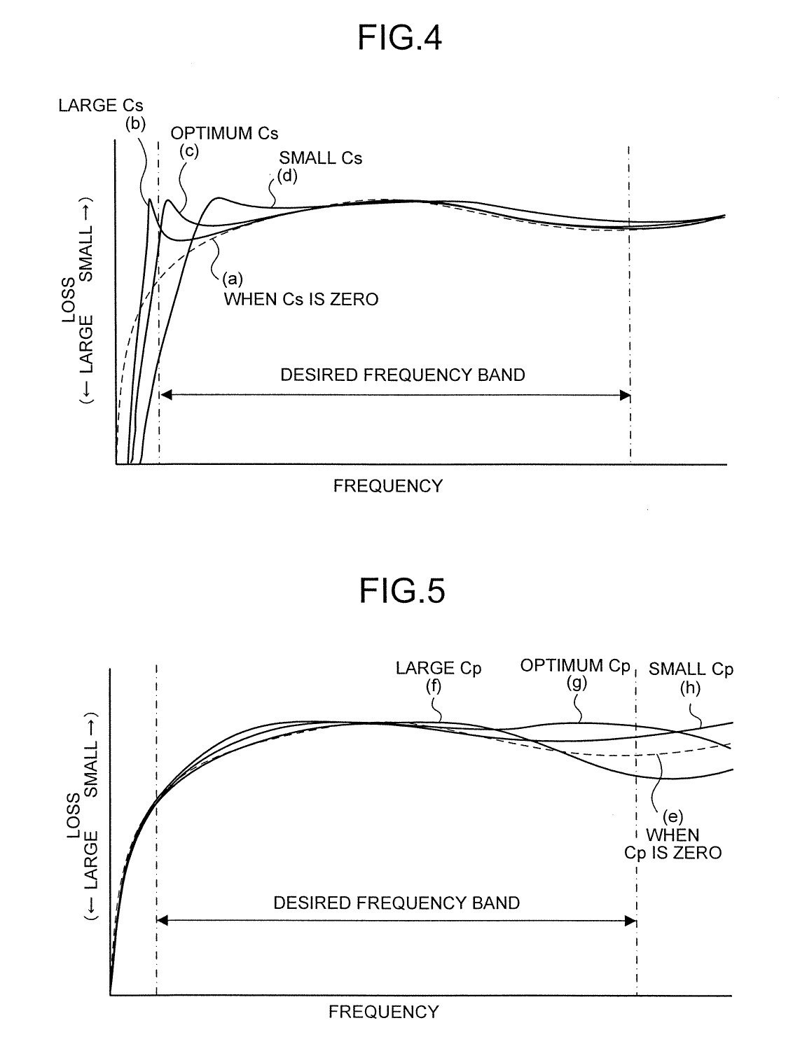

FIG. 5 is a characteristic diagram (part 2) of an example of a loss characteristic of the signal bypass device shown in FIG. 1. FIG. 5 depicts the effect of the capacitor Cp when the capacitor Cs is zero. A lateral axis of a graph shown in FIG. 5 represents frequency, and a vertical axis represents loss depending on the capacitor Cp when the capacitor Cs is zero.

In FIG. 5, a curve (e) indicated by a broken line represents a loss characteristic when the capacitor Cp is zero, i.e., when the capacitors Cp15 and Cp16 are not present. In this case, the capacitor Cs is zero, too. Loss occurs mainly due to the increase in the leakage reactance, characteristic impedance of the cable 10, a transmission delay per unit length, and a stationary wave generated from length, in the intermediate-frequency band to the high-frequency band of loss characteristic (e).

On the other hand, curves (f), (g), and (h) indicated by solid lines represent loss characteristics when the capacitor Cp is changed. The curve (f) shows loss characteristic when the capacitor Cp value is large. The curve (g) shows loss characteristic when the capacitor Cp value is optimum. The curve (h) shows loss characteristic when the capacitor Cp value is small.

Because the low-pass filter (LPF) is formed by the capacitor Cp and the two elements of the leakage inductance (1−k)*2L, sharpness of rise at the end of the cutoff frequency of the high-pass filter and the pass area and sharpness of the loss band change according to the value of the capacitor Cp. Therefore, a suitable value of the capacitor Cp in the lowest loss area of a desired frequency band is selected.

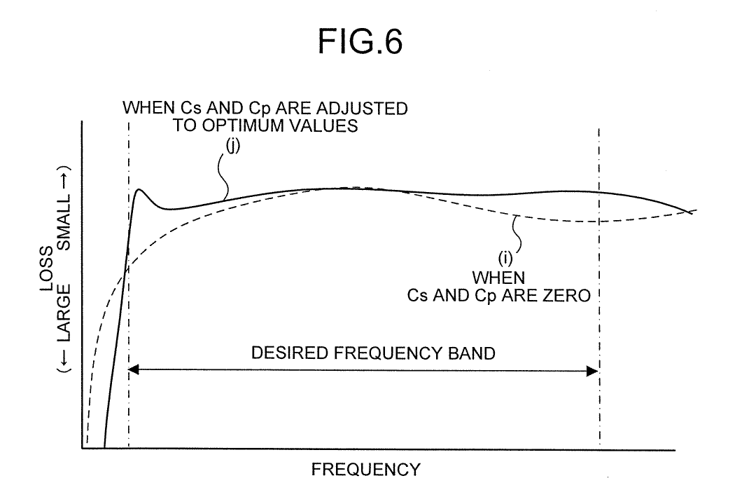

FIG. 6 is a characteristic diagram (part 3) of an example of a loss characteristic of the signal bypass device shown in FIG. 1. FIG. 6 depicts effect obtained when both the capacitor Cs and the capacitor Cp are present. A lateral axis of a graph shown in FIG. 6 represents frequency and a vertical axis represents loss depending on both of the capacitors Cs and Cp.

In FIG. 6, a curve (i) indicated by a broken line represents loss characteristic when the capacitors Cs and Cp are zero. On the other hand, a curve (j) indicated by a solid line represents loss characteristic when the capacitors Cs and Cp adjusted to the optimum values shown in FIGS. 4 and 5 are added. As shown in FIG. 6, it can be understood that when the capacitors Cs and Cp adjusted to the optimum values shown in FIGS. 4 and 5 are added in a desired frequency band, the loss can be decreased more than the case in which the capacitors Cs and Cp are zero.

As explained above, the high-frequency signals transmitted after being injected into the distribution lines 21 and 22 can be extracted by the transformers T1 and T2, and can be injected into the distribution lines 27 and 28 by the transformers T3 and T4 via the communication lines 10a and 10b. Similarly, the high-frequency signals transmitted in the opposite direction after being injected into the distribution lines 27 and 28 can be also extracted by the transformers T3 and T4, and can be injected into the distribution lines 21 and 22 by the transformers T1 and T2 via the communication lines 10a and 10b. The operations can be carried out because of the symmetrical configuration around the distributor 5.

As explained above, according to the first embodiment, the split type cores that function as transformers are disposed on the two distribution lines and connected into a cable at both sides of the distributor, as units that extract high-frequency signals from the distribution lines and inject the high-frequency signals into the distribution lines. At the same time, the capacitors are disposed between the connection ends of the distributor and the distribution lines. Therefore, the high-frequency signals can be bypassed without being affected by the loss characteristics of the distributor in the frequency band of the high-frequency signals. In this case, the extraction efficiency and the injection efficiency of the high-frequency signals by the cores that function as transformers can be increased, by the capacitors installed between the connection ends of the distributor and the distribution lines.

Capacitors of which values are adjusted to appropriate levels are set in series and in parallel at the cable side of the cores that function as transformers. Therefore, loss characteristic in a desired frequency band can be decreased. When these capacitors are used, the following useful effects can be obtained.

When loss characteristics are compared between a case in which the capacitors are used and a case in which the capacitors are not used, using cores of the same material, the same size, and the same gap length, the loss characteristic in a desired frequency band decreases in the former case compared with the latter case. On the other hand, when the capacitors are used, the size of the cores can be small to have loss characteristic in a desired frequency characteristic substantially the same as that when the capacitors are not used. Namely, the cores can be made small to have improved core setting, while maintaining substantially the same loss characteristic in a desired frequency band.

### Second Embodiment

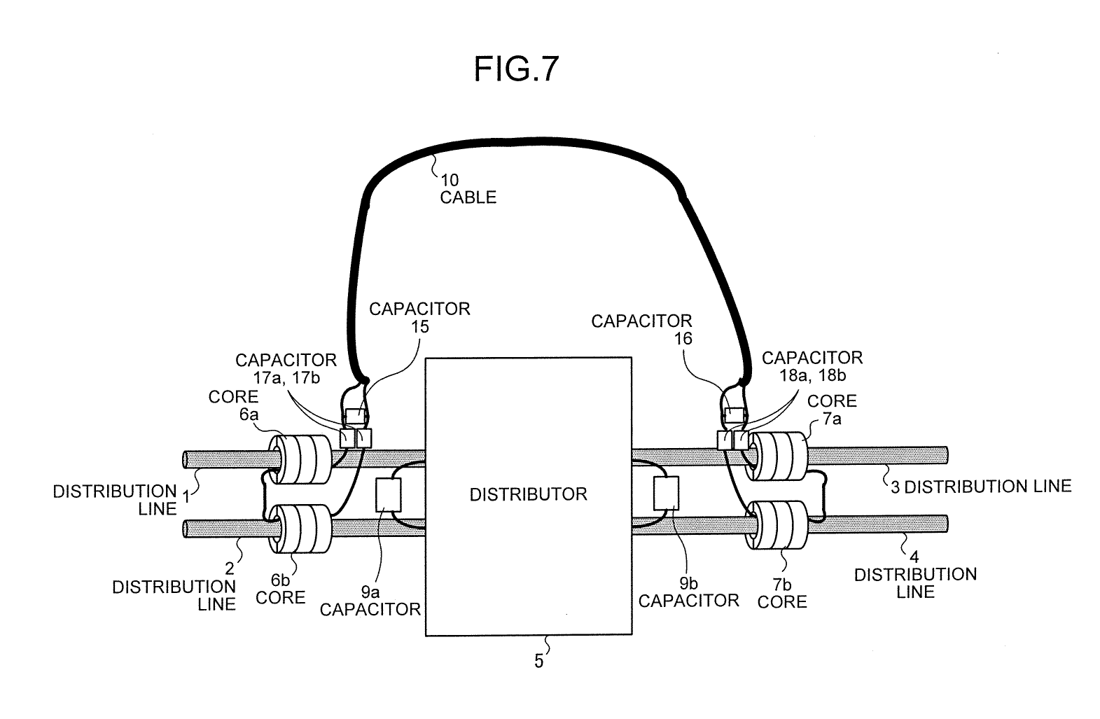

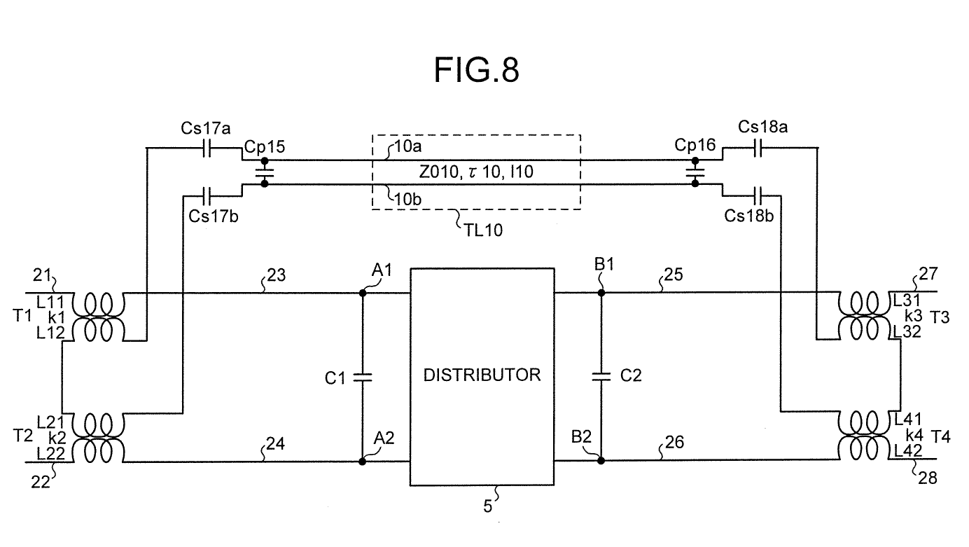

FIG. 7 depicts a layout of a signal bypass device according to a second embodiment of the present invention. FIG. 8 is an equivalent circuit diagram of a circuit configuration of the signal bypass device shown in FIG. 7. In FIG. 7 and FIG. 8, constituent elements identical with or equivalent to those shown in the first embodiment (in FIG. 1 and FIG. 2) are denoted with like reference numerals. Parts according to the second embodiment are mainly explained below.

As shown in FIG. 7, in the signal bypass device according to the second embodiment, the capacitor 17 in the configuration shown in FIG. 1 (the first embodiment) is deleted, and the output ends of the two communication lines of the cable 10 passing through the cores 6a and 6b are directly connected to each other. Capacitors 17a and 17b are present in the two signal lines at the input side of the cable 10 entering the cores 6a and 6b. Similarly, the capacitor 18 in the configuration shown in FIG. 1 (the first embodiment) is deleted, and the output ends of the two communication lines of the cable 10 passing through the cores 7a and 7b are directly connected to each other. Capacitors 18a and 18b are present in the two signal lines at the input side of the cable 10 entering the cores 6a and 6b.

Therefore, the signal bypass device shown in FIG. 7 has a circuit configuration as shown in FIG. 8. In FIG. 8, one end of the input-and-output winding at the other side of the transformer T1 is directly connected to one end of the input-and-output winding at one side of the transformer T2. The other end of the input-and-output winding at one side of the transformer T1 and the other end of the input-and-output winding at one side of the transformer T2 are connected to the communication lines 10a and 10b, respectively, via capacitors Cs17a and Cs17b corresponding to the capacitors 17a and 17b. Similarly, one end of the input-and-output winding at the other side of the transformer T3 is directly connected to one end of the input-and-output winding at the other side of the transformer T4. The other end of the input-and-output winding at one side of the transformer T3 and the other end of the input-and-output winding at one side of the transformer T4 are connected to the communication lines 10a and 10b, respectively, via capacitors Cs18a and Cs18b corresponding to the capacitors 18a and 18b.

The operation of the signal bypass device according to the second embodiment having the configuration described above is explained next with reference to FIG. 8. In the second embodiment, the layout positions of the capacitors Cs17 and Cs18 corresponds to the layout positions of the capacitors in the first embodiment that are changed to the opposite side of the input-and-output windings at the other side of the transformers T1 and T2 and the transformers T3 and T4. Therefore, a method of selecting the capacitors Cs17a and Cs17b, and the capacitors Cs18a and Cs18b is explained below.

Although the values of the capacitors Cs17 and Cs18 are selected to obtain a relationship of Cs17=Cs18=Cs in the condition of deriving the equivalent circuit shown in FIG. 3A explained in the first embodiment, the values of the capacitors Cs17a, Cs17b, Cs18a, and Cs18b in the second embodiment are selected to obtain a relationship of Cs17=Cs17b=Cs18a=Cs18b=2*Cs.

The circuit shown in FIG. 8 obtained in this way also becomes equivalent to the circuit shown in FIG. 3B. Because the loss characteristic of the signal bypass device according to the second embodiment shown in FIG. 7 and FIG. 8 is equivalent to that of the signal bypass device according to the first embodiment shown in FIG. 1 and FIG. 2, the effect similar to that of the first embodiment is obtained.

### Third Embodiment

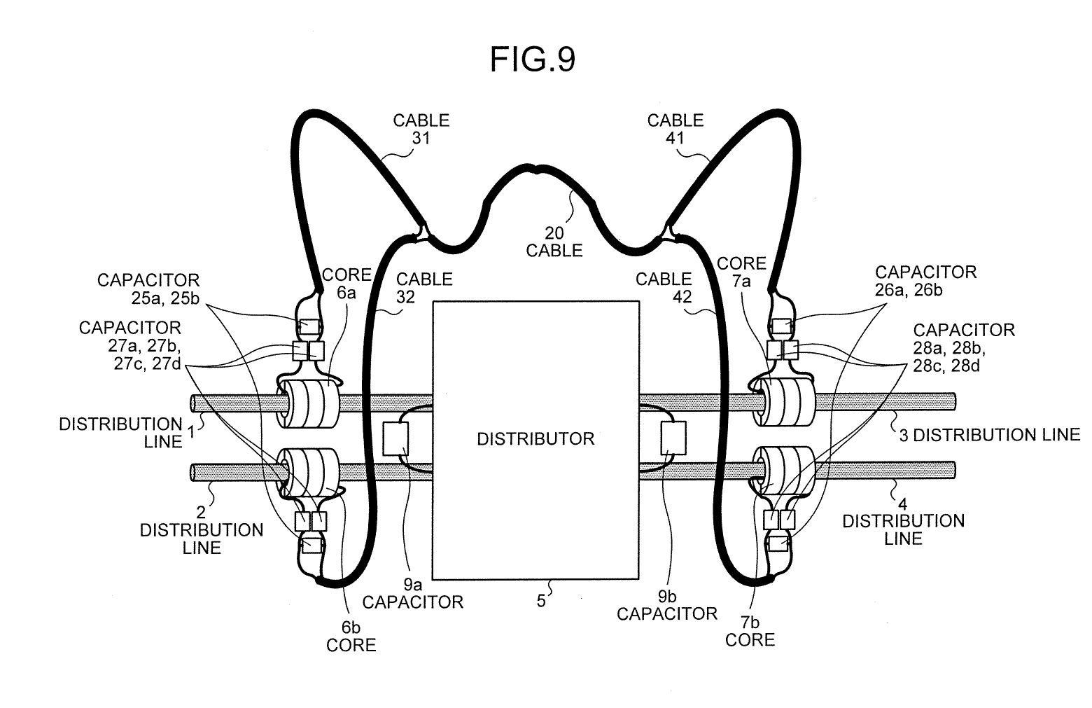

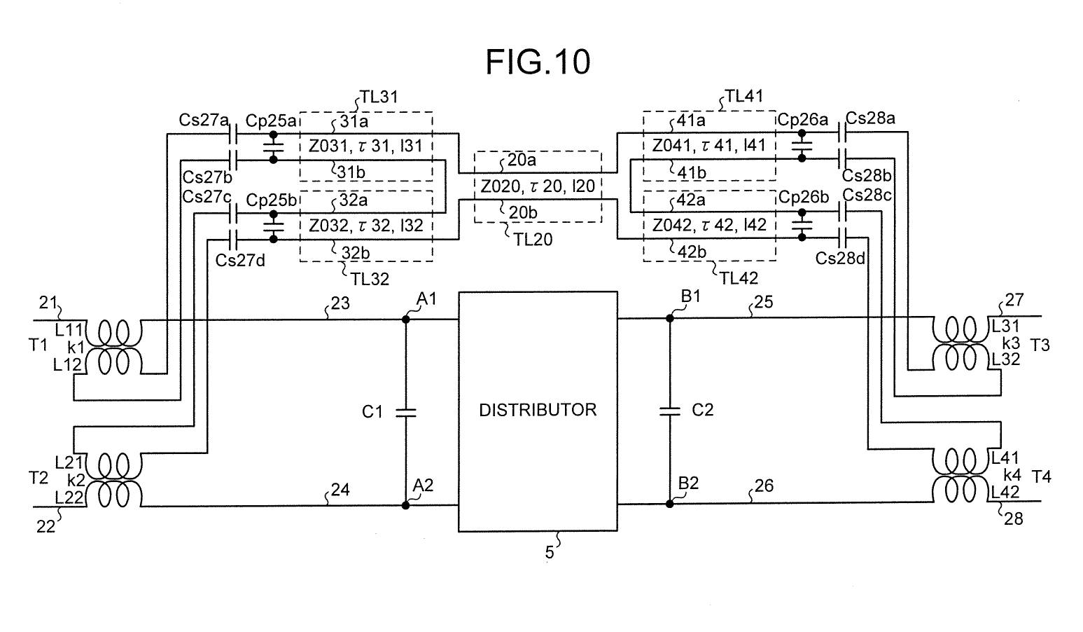

FIG. 9 depicts a layout of a signal bypass device according to a third embodiment of the present invention. FIG. 10 is an equivalent circuit diagram of a circuit configuration of the signal bypass device shown in FIG. 9. In FIG. 9 and FIG. 10, constituent elements identical with or equivalent to those shown in the second embodiment (in FIG. 7 and FIG. 8) are denoted with like reference numerals. Parts according to the third embodiment are mainly explained below.

As shown in FIG. 9, according to the signal bypass device according to the third embodiment, in place of the cable 10 in the configuration shown in FIG. 7 (the second embodiment), there are provided a cable 20, a cable 31 and a cable 32 that are connected in parallel to one end of the cable 20, and a cable 41 and a cable 42 that are connected in parallel to the other end of the cable 20.

In place of the capacitors 17a and 17b and the capacitor 15 in the configuration shown in FIG. 7 (the second embodiment), there are provided capacitors 27a and 27b and a capacitor 25a for the cable 31, and capacitors 27c and 27d and a capacitor 25b for the cable 32. Specifically, the capacitor 25a is connected to two communication lines constituting the cable 31, before the two communication lines enter the core 6a. Front ends of the two communication lines constituting the cable 31 are connected to each other via the capacitors 27a and 27b to form a loop structure, and are inserted into the core 6a. The capacitor 25b is connected to two communication lines constituting the cable 32, before the two communication lines enter the core 6b. Front ends of the two communication lines constituting the cable 32 are connected to each other via the capacitors 27c and 27d to form a loop structure, and are inserted into the core 6b.

Similarly, in place of the capacitors 18a and 18b and the capacitor 16 in the configuration shown in FIG. 7 (the second embodiment), there are provided capacitors 28a and 28b and a capacitor 26a for the cable 41, and capacitors 28c and 28d and a capacitor 26b for the cable 42. Specifically, the capacitor 26a is connected to two communication lines constituting the cable 41, before the two communication lines enter the core 7a. Front ends of the two communication lines constituting the cable 41 are connected to each other via the capacitors 28a and 28b to form a loop structure, and are inserted into the core 7a. The capacitor 26b is connected to two communication lines constituting the cable 42, before the two communication lines enter the core 6b. Front ends of the two communication lines constituting the cable 42 are connected to each other via the capacitors 28c and 28d to form a loop structure, and are inserted into the core 7b.

Therefore, the bypass device shown in FIG. 9 has a circuit configuration as shown in FIG. 10. In FIG. 10, the cable 20 shown in FIG. 9 includes a communication line 20a and a communication line 20b. Characteristic of a transmission line TL20 formed by the communication lines 20a and 20b is determined by characteristic impedance Z020, a transmission delay τ20 per unit length, and a line length l20.

The cable 31 shown in FIG. 9 includes communication lines 31a and 31b. Characteristic of a transmission line TL31 formed by the communication lines 31a and 31b is determined by characteristic impedance Z031, a transmission delay τ31 per unit length, and a line length l31. The cable 32 shown in FIG. 9 includes communication lines 32a and 32b. Characteristic of a transmission line TL32 formed by the communication lines 32a and 32b is determined by characteristic impedance Z032, a transmission delay τ32 per unit length, and a line length l32.

Similarly, the cable 41 shown in FIG. 9 includes communication lines 41a and 41b. Characteristic of a transmission line TL41 formed by the communication lines 41a and 41b is determined by characteristic impedance Z041, a transmission delay τ41 per unit length, and a line length l41. The cable 42 shown in FIG. 9 includes communication lines 42a and 42b. Characteristic of a transmission line TL42 formed by the communication lines 42a and 42b is determined by characteristic impedance Z042, a transmission delay τ42 per unit length, and a line length l42.

One end of the transmission line TL20 is branched into two of the transmission lines TL31 and TL32. In the transmission line TL31, a capacitor Cp25a as the capacitor 25a is disposed between the lines. The lines are connected to the corresponding end of the input-and-output line at the other side of the transformer T1 via the capacitors Cs27a and Cs27b as the capacitors 27a and 27b. In the transmission line TL32, a capacitor Cp25b as the capacitor 25b is disposed between the lines. The lines are connected to the corresponding end of the input-and-output line at the other side of the transformer T2 via the capacitors Cs27c and Cs27d as the capacitors 27c and 27d.

Similarly, the other end of the transmission line TL20 is branched into two of the transmission lines TL41 and TL42. In the transmission line TL41, a capacitor Cp26a as the capacitor 26a is disposed between the lines. The lines are connected to the corresponding end of the input-and-output line at the other side of the transformer T3 via the capacitors Cs28a and Cs28b as the capacitors 28a and 28b. In the transmission line TL42, a capacitor Cp26b as the capacitor 26b is disposed between the lines. The lines are connected to the corresponding end of the input-and-output line at the other side of the transformer T4 via the capacitors Cs28c and Cs28d as the capacitors 28c and 28d.

The operation of the signal bypass device according to the third embodiment having the configuration described above is explained below with reference to FIG. 10. In the third embodiment, the configuration of the signal bypass device corresponds to the following arrangement. Both ends of the transmission line formed by the cable 10 in the first and second embodiments are branched into two. A transmission line is provided for each of the transformers T1, T2, T3, and T4. The capacitors Cs17a and Cs17b and the capacitor Cp15 in the second embodiment are disposed for each of the transformers T1 and T2. The capacitors Cs18a and Cs18b and the capacitor Cp16 are disposed for each of the transformers T3 and T4.

The following explains a method of selecting the capacitors Cs27a and Cs27b and the capacitor Cs25a, the capacitors Cs27c and Cs27d and the capacitor Cs25b, the capacitors Cs28a and Cs28b and the capacitor Cs26a, and the capacitors Cs28c and Cs28d and the capacitor Cs26b. Characteristics of the transmission line TL20 at the center, the branch transmission lines TL31 and TL32 at one end of the transmission line TL20, and the branch transmission lines TL41 and TL42 at the other end of the transmission line TL20 are set as follows.

According to the second embodiment, values are selected to obtain a relationship of Cs17a=Cs17b=Cs18a=Cs18b=2*Cs. On the other hand, according to the third embodiment, values are selected to obtain a relationship of Cs27a=Cs27b=Cs27c=Cs27d=Cs28a=Cs28b=Cs28c=Cs28d=4*Cs.

In the first and second embodiments, values of the capacitors Cp15 and Cp16 are selected to obtain a relationship of Cp15=Cp16=Cp. On the other hand, in the third embodiment, values are selected to obtain a relationship of Cs25a=Cs25b=Cs26a=Cs26b=2*Cp.

Regarding the transmission line, in the first and second embodiments, the characteristic impedance Z010 in the transmission line TL10, the transmission delay τ10 per unit length, and the value of the length l10 are in the relationships of Z010=Z0, τ10=τ, and l10=l. On the other hand, in the third embodiment, characteristic values of the transmission line TL20 at the center, the branch transmission lines TL31 and TL32 at one end of the transmission line TL20, and the branch transmission lines TL41 and TL42 at the other end of the transmission line TL20 are set as follows.

In the transmission line TL20 at the center, the following relationship is set: the characteristic impedance Z020=Z0, the transmission delay τ20=τ, and the length l20=la. In the branch transmission lines TL31, TL32, TL41, and TL42, the following relationship is set: the characteristic impedance Z031=Z032=Z041=Z042=Z0/2, and the transmission delay per unit length τ31=τ32=τ41=τ42=τ. The length is set to obtain the relationship of la+lb+lc=l. In the branch transmission lines TL31 and TL32, the length is set as l31=l32=lb. In the branch transmission lines TL41 and TL42, the length is set as l41=l42=lc.

The circuit shown in FIG. 10 obtained in this way also becomes equivalent to the circuit shown in FIG. 3B. Because the loss characteristic of the signal bypass device according to the third embodiment shown in FIG. 9 and FIG. 10 is equivalent to that of the signal bypass device according to the first embodiment shown in FIG. 1 and FIG. 2, the effect similar to that of the first embodiment is obtained.

### Fourth Embodiment

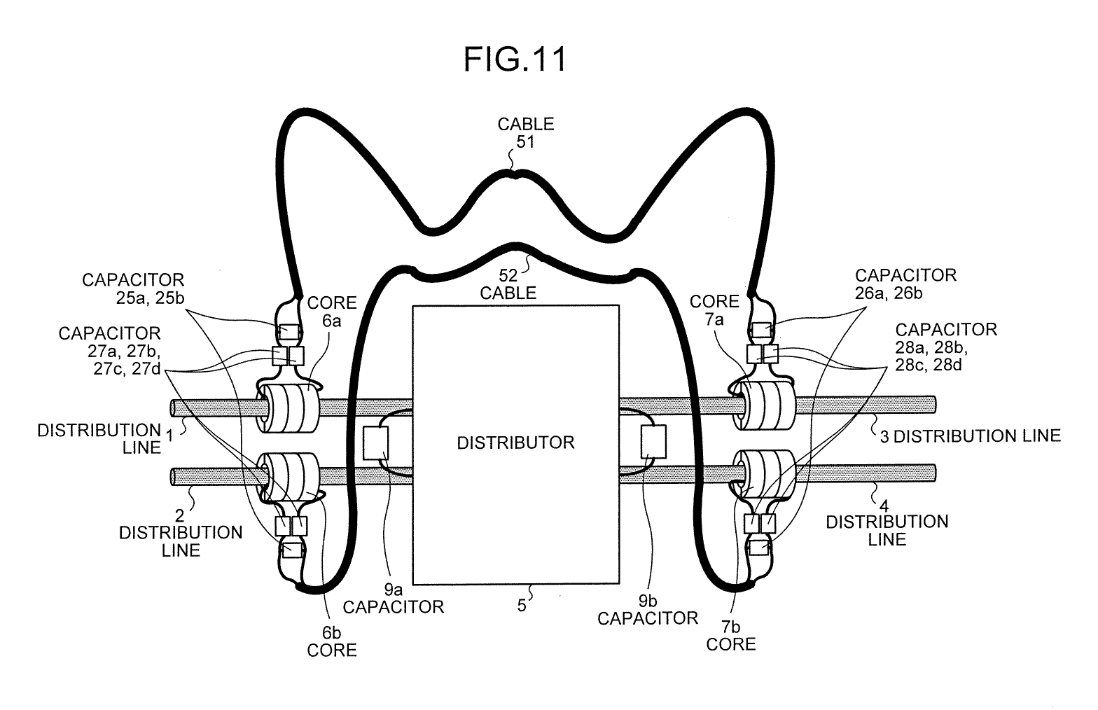

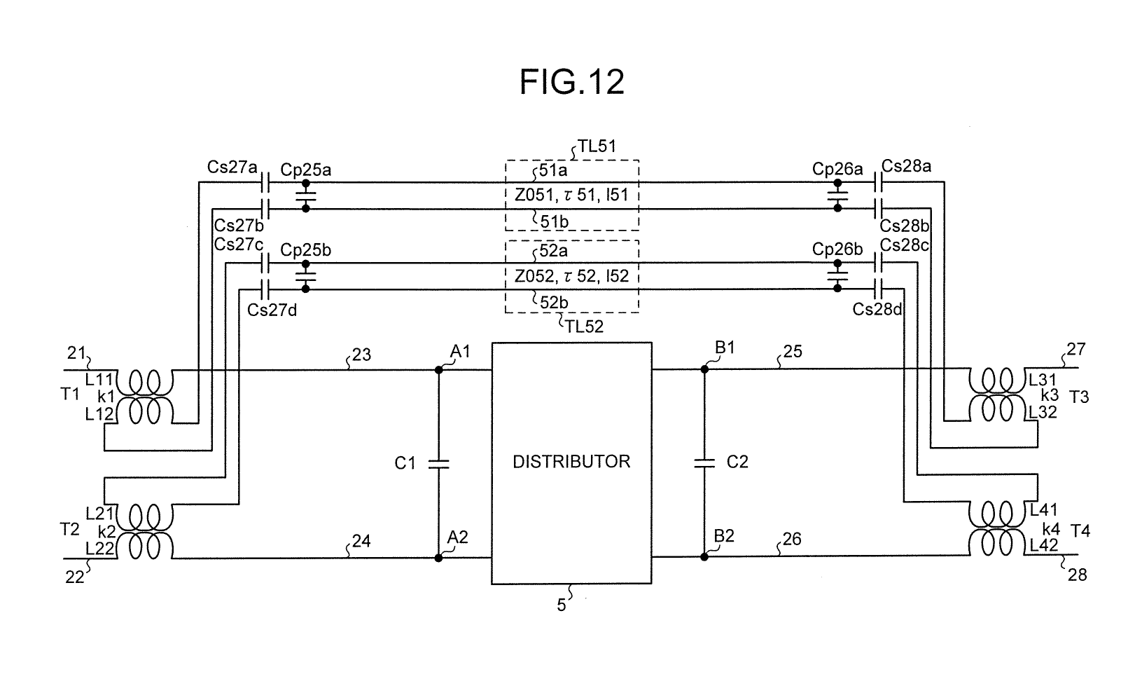

FIG. 11 depicts a layout of a signal bypass device according to a fourth embodiment of the present invention. FIG. 12 is an equivalent circuit diagram of a circuit configuration of the signal bypass device shown in FIG. 11. In FIG. 11 and FIG. 12, constituent elements identical with or equivalent to those shown in the third embodiment (in FIG. 9 and FIG. 10) are denoted with like reference numerals. Parts according to the fourth embodiment are mainly explained below.

As shown in FIG. 11, according to the signal bypass device according to the fourth embodiment, a cable 51 and a cable 52 are provided, in place of the cable 20, the cable 31, the cable 32, the cable 41, and the cable 42 shown in FIG. 9 (the third embodiment). The cable 51 corresponds to the connected cables of the cable 31, the cable 20, and the cable 41 according to the third embodiment shown in FIG. 9. The cable 52 corresponds to the connected cables of the cable 32, the cable 20, and the cable 42 in FIG. 9 (the third embodiment).

Therefore, the signal bypass device shown in FIG. 11 has a circuit configuration as shown in FIG. 12. In FIG. 12, the cable 51 shown in FIG. 11 includes a communication line 51a and a communication line 51b. Characteristic of a transmission line TL51 formed by the communication lines 51a and 51b is determined by characteristic impedance Z050, a transmission delay T51 per unit length, and a line length l51. The cable 52 shown in FIG. 11 includes a communication line 52a and a communication line 52b. Characteristic of a transmission line TL52 formed by the communication lines 52a and 52b is determined by characteristic impedance Z052, a transmission delay τ52 per unit length, and a line length l52.

The operation of the signal bypass device according to the fourth embodiment having the configuration described above is explained below with reference to FIG. 12. In the fourth embodiment, each transmission line bypassing the distributor 5 as the communication interference device sandwiches the communication interference device, with a pair of opposed transistors in the third embodiment. A characteristic value of each independent transmission line is explained.

In FIG. 12, the transmission line TL51 corresponds to a connected transmission line of the transmission line TL31, the transmission line TL20, and the transmission line TL41 shown in FIG. 10 (the third embodiment). The transmission line TL52 corresponds to a connected transmission line of the transmission line TL32, the transmission line TL20, and the transmission line TL42 shown in FIG. 10 (the third embodiment).

In the third embodiment, characteristic values of the transmission line TL20 at the center, the branch transmission lines TL31 and TL32 at one end of the transmission line TL20, and the branch transmission lines TL41 and TL42 at the other end of the transmission line TL20 are set as follows. In the transmission line TL20 at the center, the following values are set: the characteristic impedance Z020=Z0; the transmission delay τ20 per unit length=τ; and the length l20=la. In the branch transmission lines TL31, TL32, TL41, and TL42, the characteristic impedance is set Z031=Z032=Z041=Z042=Z0/2, and the transmission delay per unit length is set τ31=τ32=τ41=ττ41=τ. The length is set to obtain la+lb+lc=1. In the branch transmission lines TL31 and TL32, the length is set l31=l32=lb. In the branch transmission lines TL41 and TL42, the length is set l41=l42=lc.

On the other hand, according to the fourth embodiment, the same characteristic values are set in the transmission line TL51 and the transmission line TL52. Namely, the characteristic impedances Z051 and Z052 are set as Z051=Z052=Z0/2, the transmission delays per unit length τ51 and τ52 are set as τ51=τ52=τ, and the lengths l51 and l52 are set as l51=l52=l.

The circuit shown in FIG. 12 obtained in this way also becomes equivalent to the circuit shown in FIG. 3B. Because the loss characteristic of the signal bypass device according to the fourth embodiment shown in FIG. 11 and FIG. 12 is equivalent to that of the signal bypass device according to the first embodiment shown in FIG. 1 and FIG. 2, the effect similar to that of the first embodiment is obtained.

### Fifth Embodiment

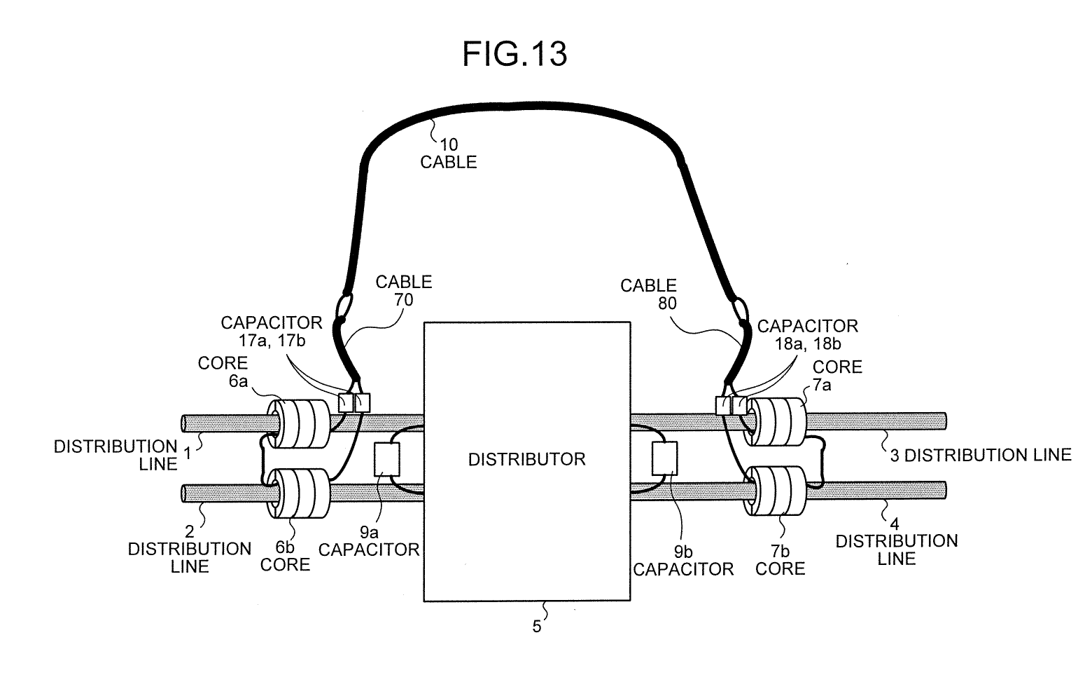

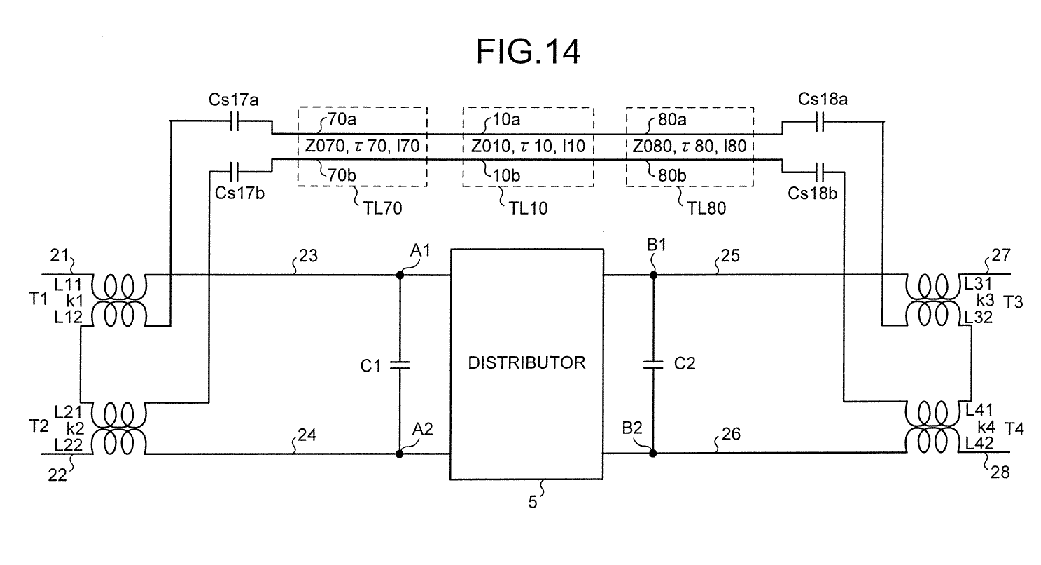

FIG. 13 depicts a layout of a signal bypass device according to a fifth embodiment of the present invention. FIG. 14 is an equivalent circuit diagram of a circuit configuration of the signal bypass device shown in FIG. 13. In FIG. 13 and FIG. 14, constituent elements identical with or equivalent to those shown in the second embodiment (in FIG. 7 and FIG. 8) are denoted with like reference numerals. Parts according to the fifth embodiment are mainly explained below.

As shown in FIG. 13, the signal bypass device according to the fifth embodiment does not include the capacitors 15 and 16 in the configuration shown in FIG. 7 (the second embodiment), and has a cable 70 inserted into between the one end of the cable 10 and the capacitors 17a and 17b, and has a cable 80 inserted into between the other end of the cable 10 and the capacitors 18a and 18b.

Therefore, the signal bypass device shown in FIG. 13 has a circuit configuration as shown in FIG. 14. In FIG. 14, the cable 70 shown in FIG. 13 includes a communication line 70a and a communication line 70b. Characteristic of a transmission line TL70 formed by the communication lines 70a and 70b is determined by characteristic impedance Z070, a transmission delay τ70 per unit length, and a line length l70. The cable 80 shown in FIG. 13 includes a communication line 80a and a communication line 80b. Characteristic of a transmission line TL80 formed by the communication lines 80a and 80b is determined by characteristic impedance Z080, a transmission delay τ80 per unit length, and a line length l80.

The operation of the signal bypass device according to the fifth embodiment having the configuration described above is explained below with reference to FIG. 14. In the fifth embodiment, a transmission line replacing the capacitor between the lines is provided at both ends of the transmission line in the second embodiment. A characteristic value of each transmission line replacing the capacitor between the lines is explained herein.

In the second embodiment, values of the capacitors Cp15 and Cp16 between the lines at both ends of the transmission line TL10 are selected to obtain a relationship of Cp15=Cp16=Cp. In the fifth embodiment, the transmission line TL70 realizes the capacitor Cp15, and the transmission line TL80 realizes the capacitor Cp16.

When the transmission lines TL70 and TL80 have a shorter length than the signal wavelength, the values of the capacitors Cp70 and Cp80 that are realized by the transmission lines LT70 and LT80 are given by the following expressions

Cp70=l70*τ70/Z070 (1)

Cp80=l80*τ80/Z080 (2)

When Cp15=CP70=Cp, and when Cp16=Cp80=Cp, the following expressions are obtained

Cp=l70*τ70/Z070 (3)

Cp=l80*τ80/Z080 (4)

### Namely, in the expressions (3) and (4), constants (l70, τ70, Z070) of the transmission line TL70 and constants (l80, τ80, Z080) of the transmission line TL80 are adjusted.

In the circuit shown in FIG. 14 obtained in this way, not only capacitance but also inductance also occurs in the transmission line TL70 and the transmission line TL80. Therefore, loss characteristic of the signal bypass device according to the fifth embodiment shown in FIG. 13 and FIG. 14 does not become equal to that of the signal bypass device according to the first embodiment shown in FIG. 1 and FIG. 2. However, loss characteristic near that of the signal bypass device according to the first embodiment can be obtained. As a result, the effect similar to that according to the first embodiment can be obtained.

### Sixth Embodiment

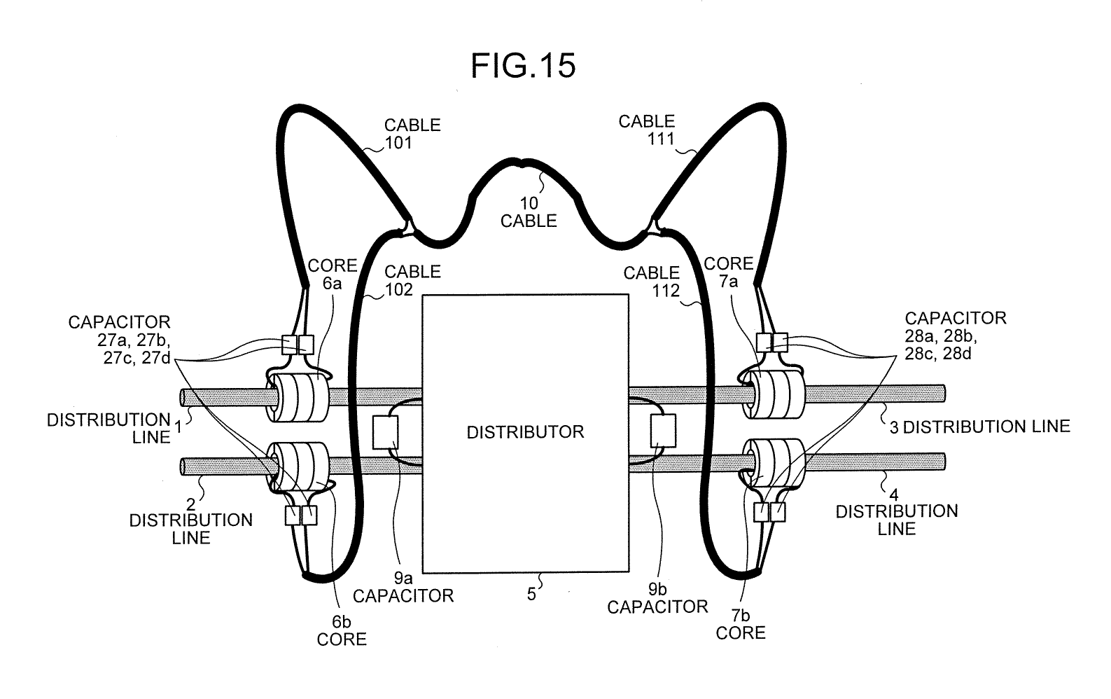

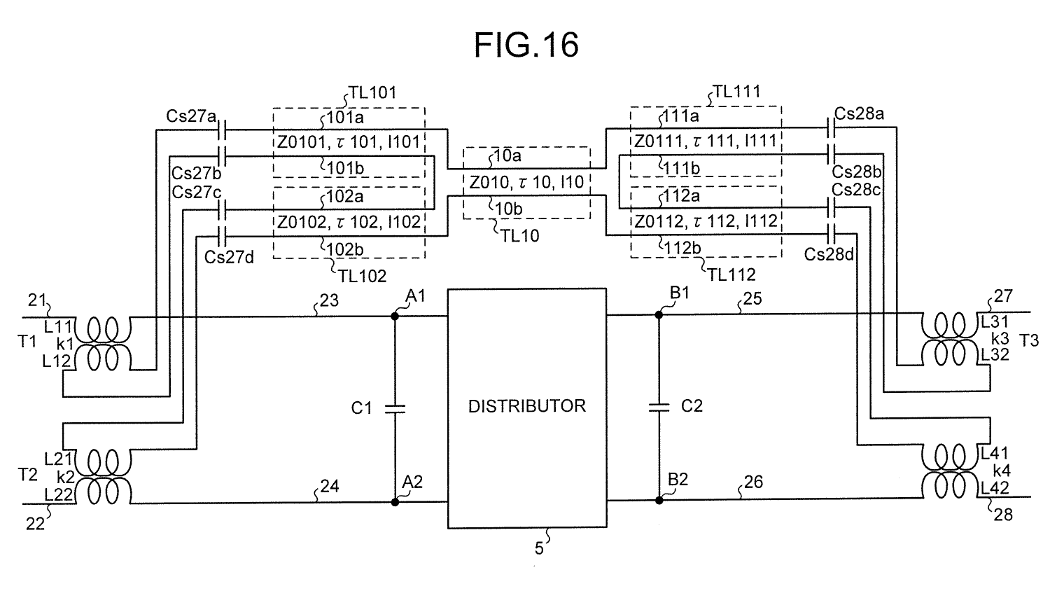

FIG. 15 depicts a layout of a signal bypass device according to a sixth embodiment of the present invention. FIG. 16 is an equivalent circuit diagram of a circuit configuration of the signal bypass device shown in FIG. 15. In FIG. 15 and FIG. 16, constituent elements identical with or equivalent to those shown in the third embodiment (in FIG. 9 and FIG. 10) are denoted with like reference numerals. Parts according to the sixth embodiment are mainly explained below.

As shown in FIG. 15, the signal bypass device according to the sixth embodiment does not include the capacitors 25a and 25b configured shown in FIG. 9 in the third embodiment, includes cables 101 and 102 in place of the cables 31 and 32, does not include the capacitors 26a and 26b, and includes cables 111 and 112 in place of the cables 41 and 42.

Therefore, the signal bypass device shown in FIG. 15 has a circuit configuration as shown in FIG. 16. In FIG. 16, the cable 101 shown in FIG. 15 includes a communication line 101a and a communication line 101b. Characteristic of a transmission line TL101 formed by the communication lines 101a and 101b is determined by characteristic impedance Z0101, a transmission delay τ101 per unit length, and a line length l101. The cable 102 shown in FIG. 15 includes a communication line 102a and a communication line 102b. Characteristic of a transmission line TL102 formed by the communication lines 102a and 102b is determined by characteristic impedance Z0102, a transmission delay T102 per unit length, and a line length l102.

Similarly, the cable 111 shown in FIG. 15 includes a communication line 111a and a communication line 111b. Characteristic of a transmission line TL111 formed by the communication lines 111a and 111b is determined by characteristic impedance Z0111, a transmission delay τ111 per unit length, and a line length l111. The cable 112 shown in FIG. 15 includes a communication line 112a and a communication line 112b. Characteristic of a transmission line TL112 formed by the communication lines 112a and 112b is determined by characteristic impedance Z0112, a transmission delay τ112 per unit length, and a line length l112.

The operation of the signal bypass device according to the sixth embodiment having the configuration described above is explained below with reference to FIG. 16. According to the sixth embodiment, branch transmission lines at both ends of the transmission line at the center according to the third embodiment substitute for the capacitor provided between the lines. Therefore, characteristic values of the branch transmission lines that substitute for the capacitor between the lines are explained below.

According to the third embodiment, the values of Cp25a, Cp25b, Cp26a, and Cp26b provided between the lines of the branch transmission lines TL31, TL32, TL41, and TL42 are Cp25a=Cp25b=Cp26a=Cp26b=2*Cp.

According to the sixth embodiment, the transmission line TL101 realizes the capacitor CP25a, and the transmission line TL102 realizes the capacitor Cp25b. The transmission line TL111 realizes the capacitor CP26a, and the transmission line TL112 realizes the capacitor Cp26b. When the lengths of the transmission lines TL101, TL102, TL111, and TL112 are shorter than the signal wavelength, the values of the capacitors Cp101, Cp102, Cp111, and Cp112 realized by these transmission lines are given by the following expressions

Cp101=l101*τ101/Z0101 (5)

Cp102=l102*τ102/Z0102 (6)

Cp11=l111*τ111/Z0111 (7)

Cp112=l112*τ112/Z0112 (8)

When Cp25a=Cp101=2*Cp, Cp25b=Cp102=2*Cp, Cp26a=Cp111=2*Cp, and Cp26a=Cp112=2*Cp, the following expressions are given

2*Cp=l101*τ101/Z0101 (9)

2*Cp=l102*τ102/Z0102 (10)

2*Cp=l111*τ111/Z0111 (11)

2*Cp=l112*τ112/Z0112 (12)

Namely, in the expression (9) to the expression (12), the values of the constants of each transmission line are adjusted to become close to 2*Cp, i.e., the constants (l101, τ101, Z0101) of the transmission line TL101, the constants (l102, τ102, Z0102) of the transmission line TL102, the constants (l111, τ111, Z0111) of the transmission line TL111, and the constants (l112, τ112, Z0112) of the transmission line TL112 are adjusted to 2*Cp.

In the circuit shown in FIG. 16 obtained in this way, not only capacitance but also inductance also occurs in the transmission lines TL101 and TL102 and the transmission lines TL111 and TL112. Therefore, loss characteristic of the signal bypass device according to the sixth embodiment shown in FIG. 15 and FIG. 16 does not become equal to that of the signal bypass device according to the first embodiment shown in FIG. 1 and FIG. 2. However, loss characteristic near that of the signal bypass device according to the first embodiment can be obtained. As a result, the effect similar to that according to the first embodiment can be obtained.

### Seventh Embodiment

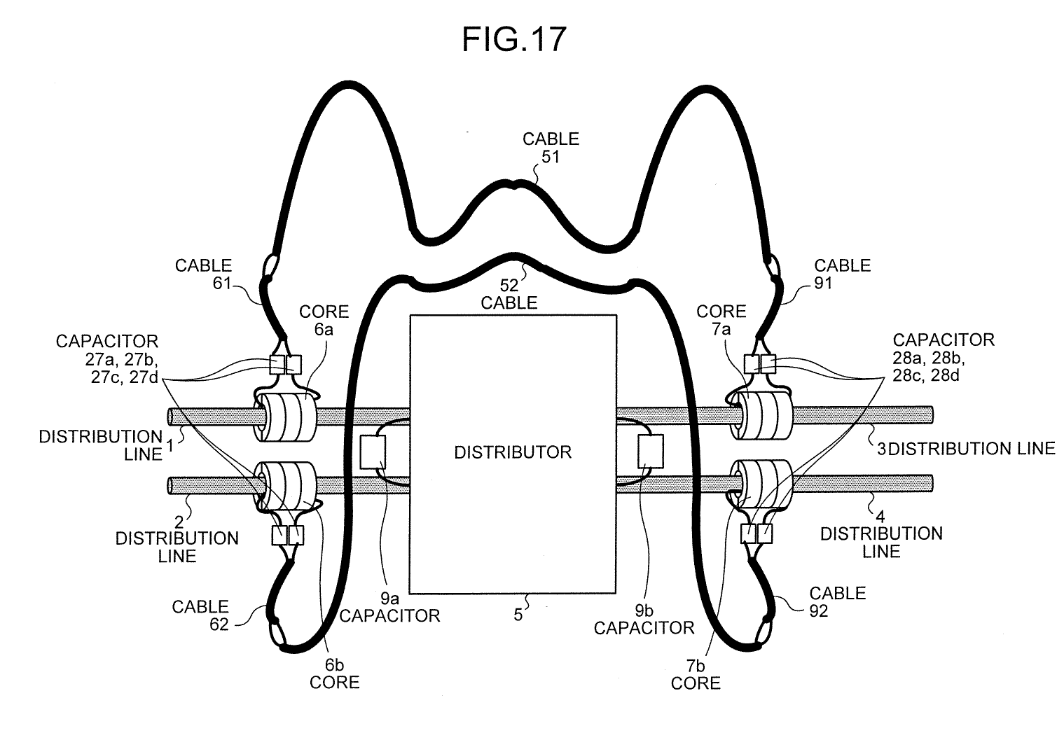

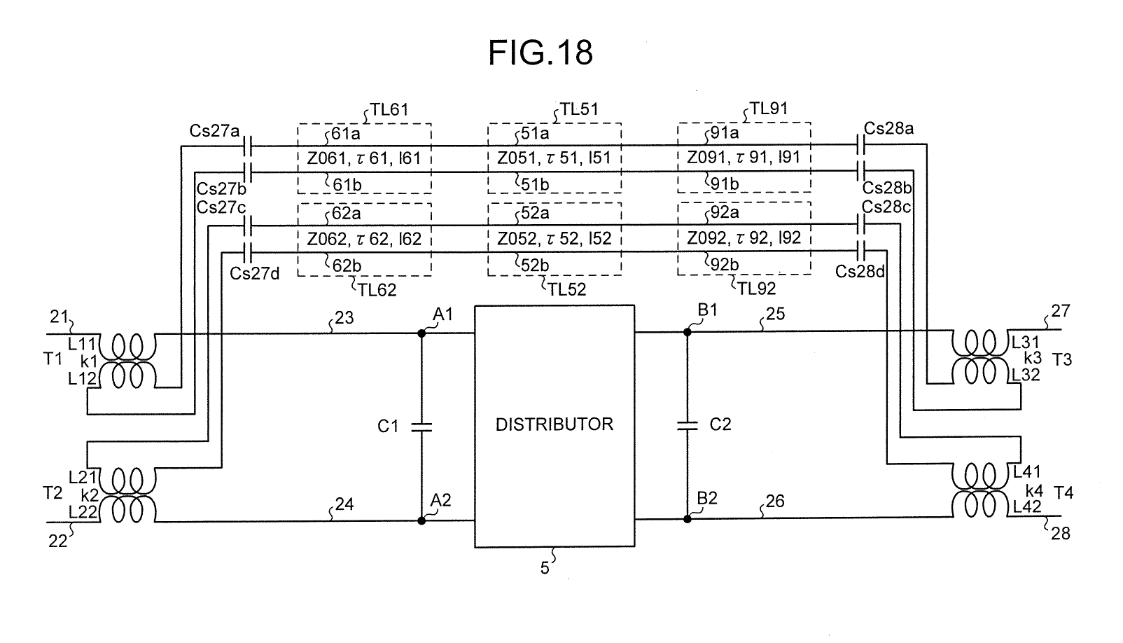

FIG. 17 depicts a layout of a signal bypass device according to a seventh embodiment of the present invention. FIG. 18 is an equivalent circuit diagram of a circuit configuration of the signal bypass device shown in FIG. 17. In FIG. 17 and FIG. 18, constituent elements identical with or equivalent to those shown in the fourth embodiment (in FIG. 11 and FIG. 12) are denoted with like reference numerals. Parts according to the seventh embodiment are mainly explained below.

As shown in FIG. 17, the signal bypass device according to the seventh embodiment does not include the capacitors 25a and 26a configured shown in FIG. 11 (the fourth embodiment), has a cable 61 inserted into between one end of the cable 51 and the capacitors 27a and 27b, and has a cable 91 inserted into between the other end of the cable 51 and the capacitors 28a and 28b.

Similarly, the signal bypass device according to the seventh embodiment does not include the capacitors 25b and 26b configured shown in FIG. 11 (the fourth embodiment), has a cable 62 inserted into between one end of the cable 52 and the capacitors 27c and 27d, and has a cable 92 inserted into between the other end of the cable 52 and the capacitors 28c and 28d.

Therefore, the signal bypass device shown in FIG. 17 has a circuit configuration as shown in FIG. 18. In FIG. 18, the cable 61 shown in FIG. 17 includes a communication line 61a and a communication line 61b. Characteristic of a transmission line TL61 formed by the communication lines 61a and 61b is determined by characteristic impedance Z061, a transmission delay τ61 per unit length, and a line length l61. The cable 91 shown in FIG. 17 includes communication lines 91a and 92b. Characteristic of a transmission line TL91 formed by the communication lines 91a and 91b is determined by characteristic impedance Z091, a transmission delay τ91 per unit length, and a line length l91.

Similarly, the cable 62 shown in FIG. 17 includes a communication line 62a and a communication line 62b. Characteristic of a transmission line TL62 formed by the communication lines 62a and 62b is determined by characteristic impedance Z062, a transmission delay T62 per unit length, and a line length l62. The cable 92 shown in FIG. 17 includes a communication line 92a and a communication line 92b. Characteristic of a transmission line TL92 formed by the communication lines 92a and 92b is determined by characteristic impedance Z092, a transmission delay τ92 per unit length, and a line length l92.

The operation of the signal bypass device according to the seventh embodiment having the configuration described above is explained below with reference to FIG. 18. According to the seventh embodiment, transmission lines substituting for capacitors are provided at both ends of an independent transmission line according to the fourth embodiment. Therefore, characteristic value of each inserted independent transmission line that substitutes for the capacitor between the lines is explained below.

According to the third embodiment, the values are selected to obtain the relationship of Cp25a=Cp25b=Cp26a=Cp26b=2*Cp. According to the seventh embodiment, the transmission line TL61 realizes the capacitor CP25a, and the transmission line TL91 realizes the capacitor Cp26a. The transmission line TL62 realizes the capacitor CP25b, and the transmission line TL92 realizes the capacitor Cp26b.

When the lengths of the transmission lines TL61, TL62, TL91, and TL92 are shorter than the signal wavelength, the values of the capacitors Cp61, Cp62, Cp91, and Cp92 realized by the transmission lines TL61, TL62, TL91, and TL92 are given by the following expressions

Cp61=l61*τ61/Z061 (13)

Cp62=l62*τ62/Z062 (14)

Cp91=l91*τ91/Z091 (15)

Cp92=l92*τ92/Z092 (16)

When Cp25a=Cp61=2*Cp, Cp25b=Cp62=2*Cp, Cp26a=Cp91=2*Cp, and Cp26b=Cp92=2*Cp, the following expressions are given

2*Cp=l61*τ61/Z061 (17)

2*Cp=l62*τ62/Z062 (18)

2*Cp=l91*τ91/Z091 (19)

2*Cp=l92*τ92/Z092 (20)

Namely, in the expression (17) to the expression (20), the values of the constants of each transmission line are adjusted to become close to Cp, i.e., the constants (l61, τ61, Z061) of the transmission line TL61, the constants (l62, τ62, Z062) of the transmission line TL62, the constants (l91, τ91, Z091) of the transmission line TL91, and the constants (l92, τ92, Z092) of the transmission line TL92 are adjusted to Cp.

In the circuit shown in FIG. 18 obtained in this way, not only capacitance but also inductance also occurs in the transmission lines TL61, TL62, TL91, and TL92. Therefore, loss characteristic of the signal bypass device according to the seventh embodiment shown in FIG. 17 and FIG. 18 does not become equal to that of the signal bypass device according to the first embodiment shown in FIG. 1 and FIG. 2. However, loss characteristic near that of the signal bypass device according to the first embodiment can be obtained. As a result, the effect similar to that according to the first embodiment can be obtained.

### Eighth Embodiment

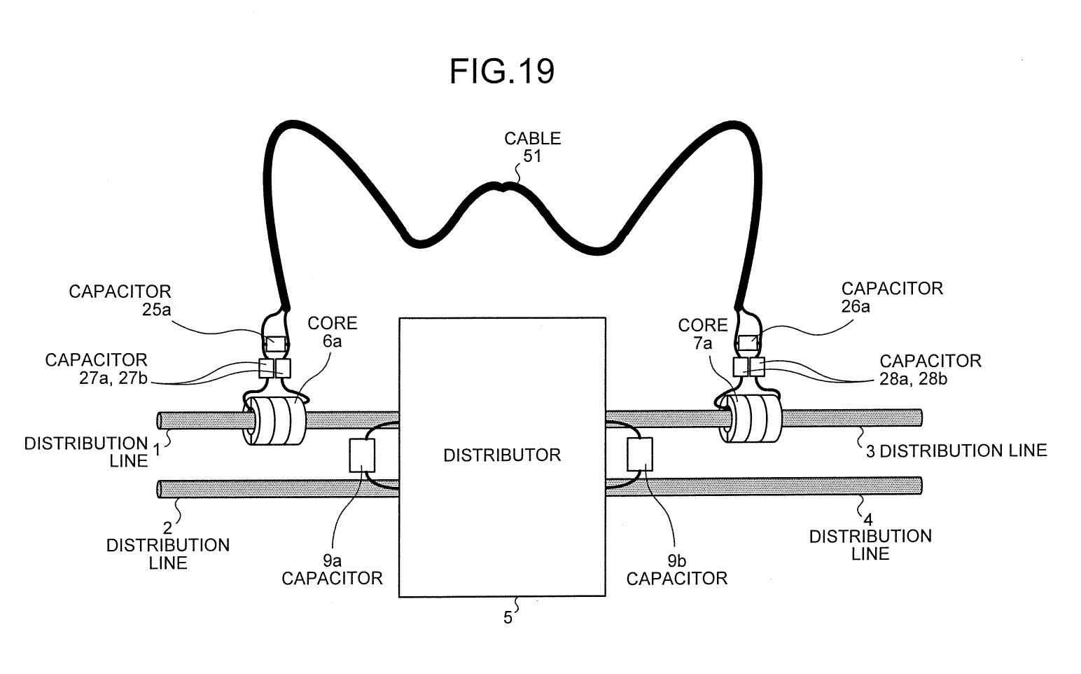

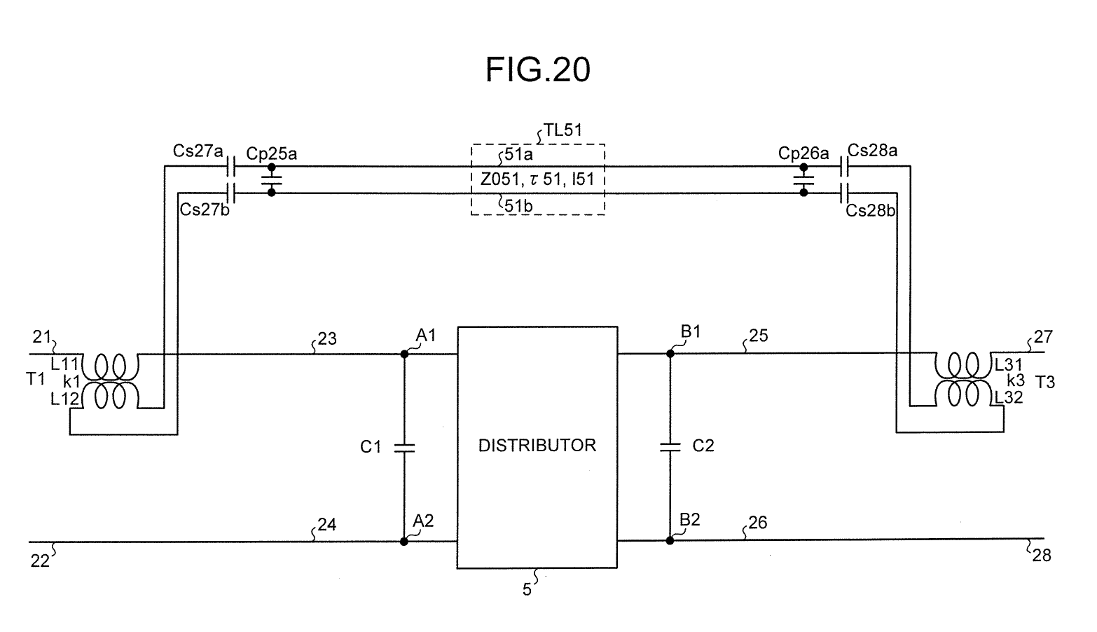

FIG. 19 depicts a layout of a signal bypass device according to an eighth embodiment of the present invention. FIG. 20 is an equivalent circuit diagram of a circuit configuration of the signal bypass device shown in FIG. 19. In FIG. 19 and FIG. 20, constituent elements identical with or equivalent to those shown in the fourth embodiment (in FIG. 11 and FIG. 12) are denoted with like reference numerals. Parts according to the seventh embodiment are mainly explained below.

As shown in FIG. 19, the signal bypass device according to the eighth embodiment does not include the core 6b set in the distribution line 2, and the cores 7b, the cable 52, and the capacitors 25b, 26b, 27c, 27d, 28c, and 28d set in the distribution line 4 in the configuration shown in FIG. 11 (the fourth embodiment).

Accordingly, as shown in FIG. 20, the signal bypass device shown in FIG. 19 includes the transformers T1 and T3 opposite to each other sandwiching the distributor 5, and the capacitors Cs27a, Cs27b, and Cp25a, the power transmission line TL51, and the capacitors Cp26a, Cs28a, and Cs28b disposed between the other input-and-output windings of the T1 and T3. In this configuration, communication signals between the distribution line 1 and the distribution line 2 can be exchanged by bypassing the distributor 5.

### Ninth Embodiment

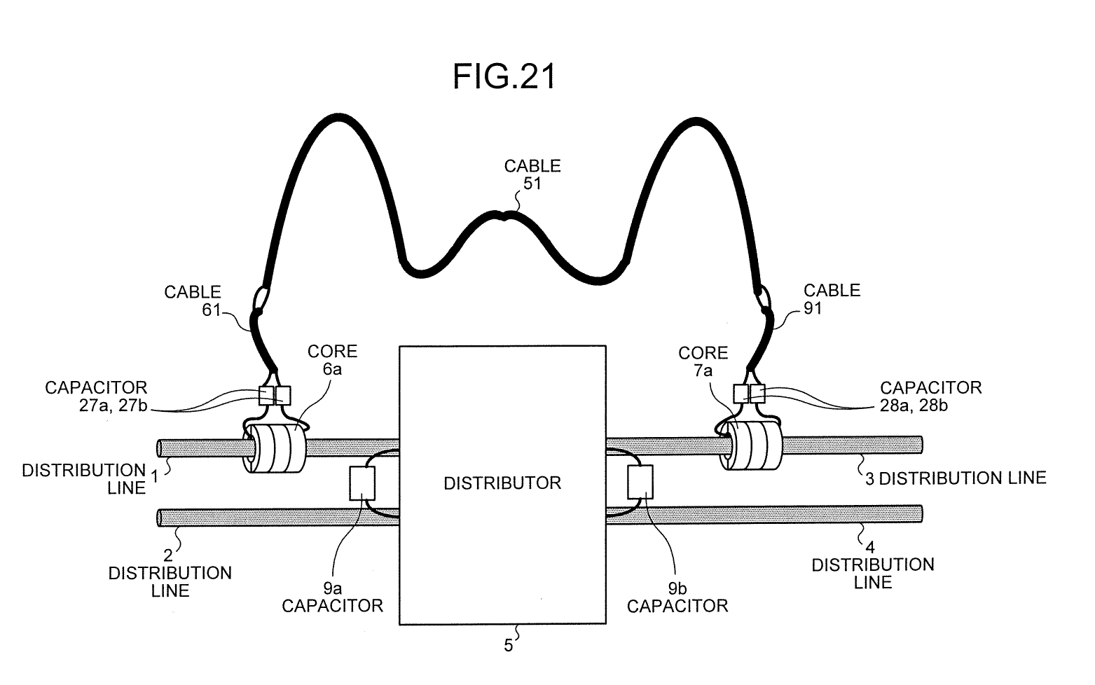

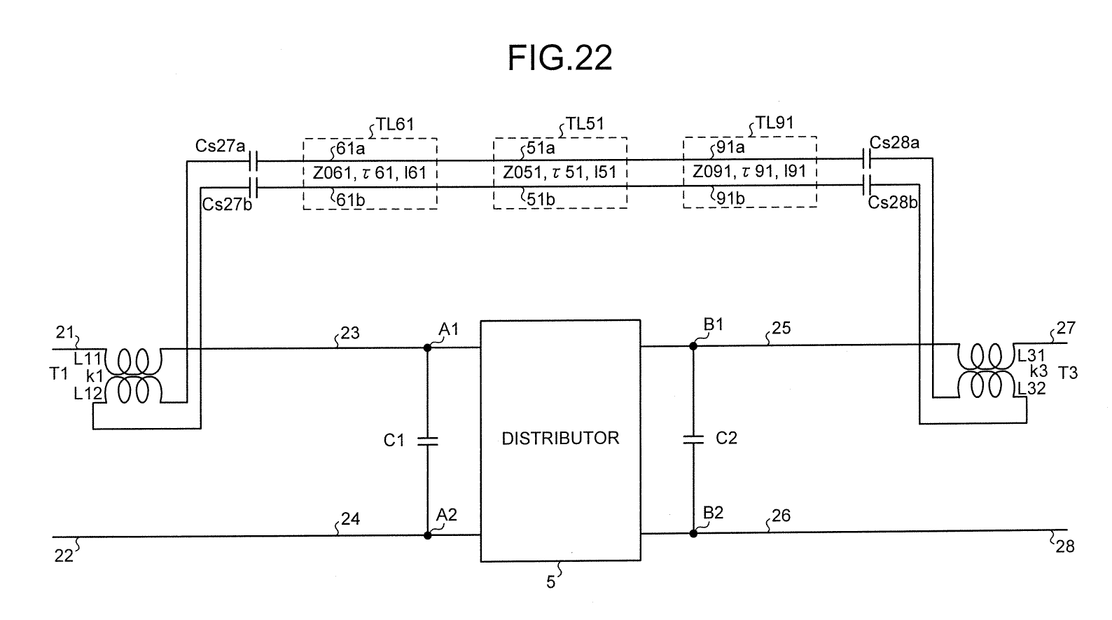

FIG. 21 depicts a layout of a signal bypass device according to a ninth embodiment of the present invention. FIG. 22 is an equivalent circuit diagram of a circuit configuration of the signal bypass device shown in FIG. 21. In FIG. 21 and FIG. 22, constituent elements identical with or equivalent to those shown in FIG. 17 and FIG. 18 (the seventh embodiment) are denoted with like reference numerals. Parts according to the ninth embodiment are mainly explained below.

As shown in FIG. 21, the signal bypass device according to the ninth embodiment does not include the core 6b disposed on the distribution line 2, and the core 7b, the cables 52, 62, and 92, and the capacitors 27c, 27d, 28c, and 28d disposed on the distribution line 4 in the configuration shown in FIG. 17 (the seventh embodiment).

Accordingly, as shown in FIG. 20, the signal bypass device shown in FIG. 21 includes the transformers T1 and T3 opposite to each other sandwiching the distributor 5, and the capacitors Cs27a and Cs27b, the power transmission line TL61, the power transmission line TL51, the power transmission line TL91, and the capacitors Cs28a and Cs28b disposed between the other input-and-output windings of the T1 and T3. In this configuration, communication signals between the distribution line 1 and the distribution line 2 can be exchanged by bypassing the distributor 5.

### Tenth Embodiment

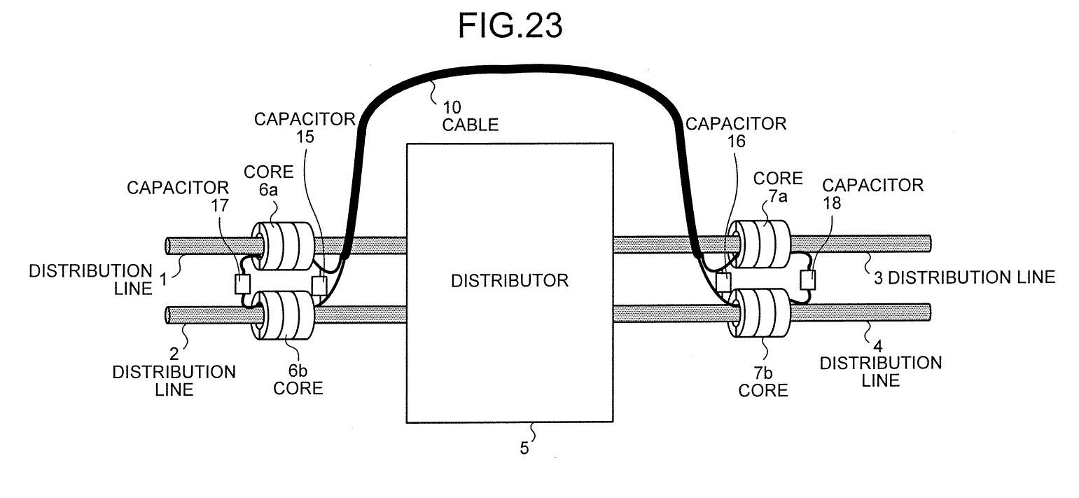

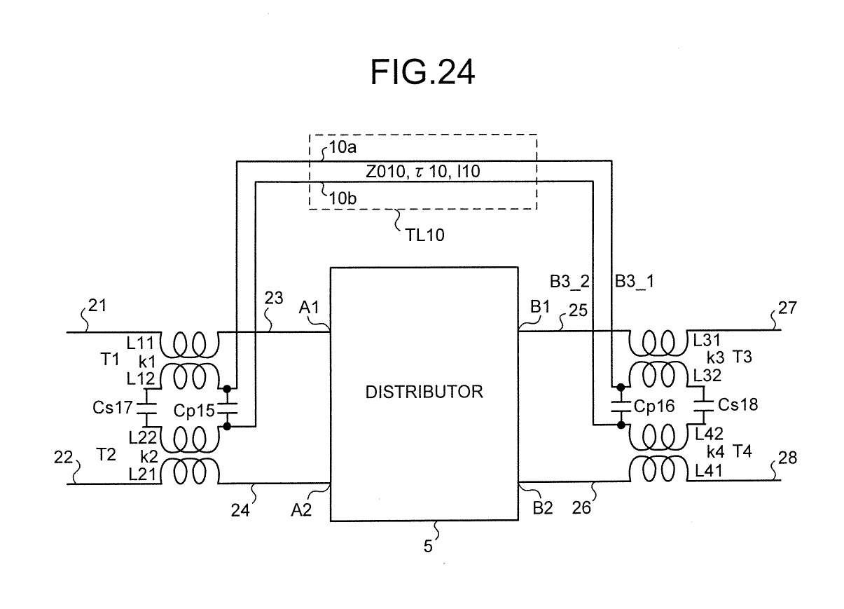

FIG. 23 depicts a layout of a signal bypass device according to a tenth embodiment of the present invention. FIG. 24 is an equivalent circuit diagram of a circuit configuration of the signal bypass device shown in FIG. 23. In FIG. 23 and FIG. 24, constituent elements identical with or equivalent to those shown in the first embodiment (in FIG. 1 and FIG. 2) are denoted with like reference numerals. Parts according to the tenth embodiment are mainly explained below.

As shown in FIG. 23, the signal bypass device according to the tenth embodiment dose not include the capacitors 9a and 9b in the configuration shown in FIG. 1 (the first embodiment). Therefore, as shown in FIG. 24, the signal bypass device shown in FIG. 23 does not include the capacitor C1 between the connection points A1 and A2 and the capacitor C2 between the connection points B1 and b2.

The effect of the capacitor 9a (C1) and the capacitor 9b (C2) is explained in the first embodiment. However, signals can be also bypassed without the capacitors 9a and 9b, by the capacitance component contained in the distributor 5, contained in the lines from the cores 6a and 6b to the distributor 5, and contained in the line from the cores 7a and 7b to the distributor 5. When the capacitors 9a and 9b are installed, the effect of the decrease in the loss characteristic of the signal bypass device becomes naturally larger, and the effect of not easily receiving the influence of the characteristic of the distributor 5 is large.

While application of the modification of the present invention to the first embodiment is explained in the tenth embodiment, it is needless to mention that the modification can be similarly applied to all other embodiments from the second to ninth embodiments.

In the first to tenth embodiments, it is explained that a high-pass filter is formed and a capacitor to decrease the loss characteristic at the low-frequency side is installed in the cable. It is also explained that a low-pass filter is formed and a capacitor to decrease the loss characteristic in the intermediate to the high-frequency sides is installed in the cable. A higher-order filter can be also additionally provided to decrease the loss characteristic. In this case, inductors and capacitors can be added corresponding to the order.

In the first to tenth embodiments, it is explained that a high-pass filter is formed and a capacitor and a low-pass filter to decrease the loss characteristic at the low-frequency side are installed in the cable. It is also explained that a low-pass filter is formed and a capacitor to decrease the loss characteristic in the intermediate to the high-frequency sides is installed in the cable. However, both capacitors do not need to be simultaneously used, and only one of them is sufficiently used.

In the first to tenth embodiments, a case is explained as an example, in which a distribution line is applied as a communication line and a distributor is bypassed in the power line communication device as a communication device. However, there is no limit to the arrangement described above. In the present invention, the communication device can be other than the power line communication device, the communication line can be a metal line other than the distribution line, and a device other than the distributor can be bypassed.

### INDUSTRIAL APPLICABILITY

As explained above, the signal bypass device according to the present invention can transmit communication signals on the power line by bypassing the communication interference device present in the middle irrespective of the type of the communication interference device. Therefore, the signal bypass device is useful to transmit high-frequency signals using an optional power line, not only for power line communication for transmitting high-frequency signals using a power line.

1. A signal bypass device comprising, when a communication interference device is present in the middle of two electric wires:
split cores arranged on each of the two electric wires at both ends of the communication interference device;
a cable wired through the split cores on each side of the ends of the communication interference device in such a manner that the split cores at both ends of the communication interference device function as transformers; and
at least one of a series capacitor through which the cable is connected and a parallel capacitor arranged across lines of the cable, the capacitors being provided near a portion where the cable passes through the split cores on each side of the ends of the communication interference device.

2. The signal bypass device according to claim 1, wherein the cable is formed with a single cable wired through the two split cores on each side of the ends of the communication interference device.

3. The signal bypass device according to claim 1, wherein the cable is formed with two cables wired through the two split cores on each side of the ends of the communication interference device.

4. The signal bypass device according to claim 1, wherein the parallel capacitor is any one of a capacitor connected across the lines of the cable passing through the split cores and a capacitor realized by other cable added to the cable with a line constant adjusted.

5. The signal bypass device according to claim 1, further comprising a capacitor connecting electric wire connection ends on each side of the ends of the communication interference device.

6. The signal bypass device according to claim 1, further comprising a higher-order filter configured with an inductor and a capacitor near the portion where the cable passes through the split cores on each side of the ends of the communication interference device.

7. A signal bypass device comprising, when a communication interference device is present in the middle of two electric wires:
split cores arranged on each of the two electric wires at both ends of the communication interference device;
a cable that connects the split cores at both ends of the communication interference device in such a manner that the split cores function as transformers, the cable including a main cable and two sets sub-cables respectively connected in parallel to the ends of the main cable, the sub-cables having a half of characteristic impedance of the main cable, two corresponding sub-cables being individually wired to pass through the two split cores; and
at least one of a series capacitor through which each of the two sub-cables is connected and a parallel capacitor arranged across lines of each of the two sub-cables, the capacitors being provided near a portion where corresponding two sub-cables pass through the two split cores on each side of the ends of the communication interference device.

8. The signal bypass device according to claim 7, wherein the parallel capacitor is any one of a capacitor connected across the lines of the two sub-cables individually passing through the two split cores and a capacitor realized by adjusting a line constant of each of the two sub-cables.

9. The signal bypass device according to claim 7, further comprising a capacitor connecting electric wire connection ends on each side of the ends of the communication interference device.

10. The signal bypass device according to claim 7, further comprising a higher-order filter configured with an inductor and a capacitor near the portion where the corresponding two sub-cables pass through the two split cores on each side of the ends of the communication interference device.

11. A signal bypass device comprising, when a communication interference device is present in the middle of two electric wires:
split cores arranged on one electric wire at both ends of the communication interference device;
a cable wired through the split cores on each side of the ends of the communication interference device in such a manner that the split cores at both ends of the communication interference device function as transformers; and
at least one of a series capacitor through which the cable is connected and a parallel capacitor arranged across lines of the cable, the capacitors being provided near a portion where the cable passes through the split cores on each side of the ends of the communication interference device.

12. The signal bypass device according to claim 11, wherein the parallel capacitor is any one of a capacitor connected across the lines of the cable passing through the split cores and a capacitor realized by other cable added to the cable with a line constant adjusted.

13. The signal bypass device according to claim 11, further comprising a capacitor connecting electric wire connection ends on each side of the ends of the communication interference device.

14. The signal bypass device according to claim 11, further comprising a higher-order filter configured with an inductor and a capacitor near a portion where the cable passes through the split cores on each side of the ends of the communication interference device.
